(19) United States
(12) Patent Application Publication
(10) Pub. No.: US 2025/0286930 A1
(43) Pub. Date: Sep. 11, 2025

(54) INFORMATION SYNCHRONIZATION METHOD AND APPARATUS, ENGINE SERVER, AND STORAGE MEDIUM

(71) Applicant: Tencent Technology (Shenzhen) Company Limited, Shenzhen (CN)

(72) Inventor: Feng CHEN, Shenzhen (CN)

(21) Appl. No.: 19/219,876

(22) Filed: May 27, 2025

Related U.S. Application Data
(63) Continuation of application No. PCT/CN2024/085432, filed on Apr. 2, 2024.

(30) Foreign Application Priority Data
May 4, 2023 (CN) 202310490284.6

(51) Int. Cl. H04L 67/131; H04L 67/1095

(52) U.S. Cl. CPC H04L 67/131; H04L 67/1095

(57) ABSTRACT

Embodiments of this application disclose an information synchronization method performed by a computer device. The method includes: obtaining absolute pose information of a virtual object in a virtual scene at a current moment; determining a serialization mechanism for the absolute pose information; when the serialization mechanism has the following value change characteristic: a data volume of data obtained by performing serialization on pose information by using the serialization mechanism is positively correlated with a value of the corresponding pose information, obtaining relative pose information of the virtual object at the current moment based on the value change characteristic of the serialization mechanism; and writing the obtained relative pose information into a property synchronization data stream corresponding to a client by using the serialization mechanism, to transmit the property synchronization data stream to the corresponding client.

### CROSS-REFERENCE TO RELATED APPLICATIONS

This application is a continuation application of PCT Patent Application No. PCT/CN2024/085432, entitled “INFORMATION SYNCHRONIZATION METHOD AND APPARATUS, ENGINE SERVER, AND STORAGE MEDIUM” filed on Apr. 2, 2024, which claims priority to Chinese Patent Application No. 202310490284.6, entitled “INFORMATION SYNCHRONIZATION METHOD AND APPARATUS, ENGINE SERVER, AND STORAGE MEDIUM” filed with the China National Intellectual Property Administration on May 4, 2023, both of which are incorporated by reference herein in their entirety.

### FIELD OF THE TECHNOLOGY

This application relates to the field of Internet technologies, specifically, to the field of communication technologies, and in particular, to an information synchronization technology.

### BACKGROUND OF THE DISCLOSURE

Currently, in a process of displaying a virtual scene, information related to a virtual object (Actor) in the virtual scene is frequently synchronized between an engine server corresponding to the virtual scene and a client. In the synchronized information, pose information of the virtual object occupies a large proportion, and a bandwidth required by the pose information accounts for approximately half or even more of a total bandwidth. During information synchronization, the engine server performs serialization processing on absolute pose information of the virtual object, to synchronize a serialization result of the absolute pose information to the client. Such a synchronization manner needs to consume a lot of bandwidths, resulting in low synchronization efficiency.

### SUMMARY

Embodiments of this application provide an information synchronization method and apparatus, an engine server, and a storage medium, which can reduce a data volume for pose synchronization, thereby effectively reducing bandwidth costs, and improving synchronization efficiency of pose information.

According to an aspect, an embodiment of this application provides an information synchronization method, performed by a computer device, the method including:
obtaining absolute pose information of a virtual object in a virtual scene at a current moment, the absolute pose information at the current moment being pose information determined based on a reference object at the current moment;
determining a serialization mechanism for the absolute pose information;
when the serialization mechanism has the following value change characteristic: a data volume of data obtained by performing serialization on pose information by using the serialization mechanism is positively correlated with a value of the corresponding pose information, obtaining relative pose information of the virtual object at the current moment based on the value change characteristic of the serialization mechanism; and
writing the obtained relative pose information into a property synchronization data stream corresponding to a client by using the serialization mechanism, to transmit the property synchronization data stream to the client.

According to still another aspect, an embodiment of this application provides a computer device, including an input interface and an output interface, and further including:
a processor, adapted to implement one or more computer programs; and
a computer storage medium, having one or more computer programs stored therein, the one or more computer programs being adapted to be loaded by the processor to perform the foregoing information synchronization method.

According to still another aspect, an embodiment of this application provides a non-transitory computer storage medium, having one or more computer programs stored therein, the one or more computer programs being adapted to be loaded by a processor to perform the foregoing information synchronization method.

In the embodiments of this application, a value change characteristic analysis may be performed on a serialization mechanism for absolute pose information, and it is learned that the serialization mechanism has the following value change characteristic: a data volume of data obtained by performing serialization on any pose information by using the serialization mechanism is positively correlated with a value of the corresponding pose information. In this way, after absolute pose information of a virtual object in a virtual scene at a current moment is obtained, relative pose information of the virtual object at the current moment may be obtained by considering the value change characteristic of the serialization mechanism. Because the obtained relative pose information is configured for indicating a difference between the absolute pose information of the virtual object at the current moment and absolute pose information of the virtual object at a previous moment, a value of the relative pose information is much less than a value of the absolute pose information, and particularly, when a difference between absolute pose information at two adjacent moments is relatively small, the value of the relative pose information may be a very small value. In this case, compared with serialization of an absolute pose, the relative pose information is written into a property synchronization data stream by using the serialization mechanism, which can effectively reduce a data volume for pose synchronization, thereby effectively reducing bandwidth costs, and improving synchronization efficiency of pose information.

### BRIEF DESCRIPTION OF THE DRAWINGS

To describe technical solutions in embodiments of this application more clearly, the following briefly introduces the accompanying drawings required for describing the embodiments. Apparently, the accompanying drawings in the following description show some embodiments of this application, and a person of ordinary skill in the art may still derive other accompanying drawings from these accompanying drawings without creative efforts.

FIG. 1A is a schematic diagram of performing communication between an engine server and a client according to an embodiment of this application.

FIG. 1B is a schematic diagram of a serialized format of a serialization mechanism according to an embodiment of this application.

FIG. 1C is a schematic diagram of a serialization result obtained by performing serialization processing on an absolute location and a relative location of a virtual object according to an embodiment of this application.

FIG. 1D is a schematic diagram of a serialized format of another serialization mechanism according to an embodiment of this application.

FIG. 2 is a schematic flowchart of an information synchronization method according to an embodiment of this application.

FIG. 3 is a schematic diagram of processing logic used when an engine server obtains relative pose information according to an embodiment of this application.

FIG. 4 is a schematic flowchart of an information synchronization method according to another embodiment of this application.

FIG. 5A is a schematic diagram of a serialized data format according to an embodiment of this application.

FIG. 5B is a schematic diagram of a historical pose information array according to an embodiment of this application.

FIG. 5C is a schematic diagram of a pose information synchronization situation between an engine server and a client according to an embodiment of this application.

FIG. 5D is a schematic diagram of a processing process related to applying an information synchronization method to a game scene according to an embodiment of this application.

FIG. 5E is a schematic diagram of processing logic related to synchronizing relative pose information according to an embodiment of this application.

FIG. 6A is a schematic diagram of a test case according to an embodiment of this application.

FIG. 6B is a schematic diagram of a test result according to an embodiment of this application.

FIG. 6C is a schematic diagram of another test result according to an embodiment of this application.

FIG. 6D is a schematic diagram of a test case according to another embodiment of this application.

FIG. 6E is a schematic diagram of a test result according to another embodiment of this application.

FIG. 6F is a schematic diagram of a test case according to still another embodiment of this application.

FIG. 6G is a schematic diagram of a statistical result corresponding to absolute pose information according to an embodiment of this application.

FIG. 6H is a schematic diagram of a statistical result corresponding to relative pose information according to an embodiment of this application.

FIG. 6I is a schematic diagram of a statistical result corresponding to another absolute pose information according to an embodiment of this application.

FIG. 6J is a schematic diagram of a statistical result corresponding to another relative pose information according to an embodiment of this application.

FIG. 6K is a schematic diagram of a statistical result according to another embodiment of this application.

FIG. 6L is a schematic diagram of another statistical result according to another embodiment of this application.

FIG. 7 is a schematic structural diagram of an information synchronization apparatus according to an embodiment of this application.

FIG. 8 is a schematic structural diagram of an engine server according to an embodiment of this application.

### DESCRIPTION OF EMBODIMENTS

The following clearly and completely describes technical solutions in the embodiments of this application with reference to the accompanying drawings in the embodiments of this application.

The embodiments of this application may relate to an artificial intelligence (AI) technology. Information synchronization is automatically implemented by using the artificial intelligence technology. The embodiments of this application mainly relate to a program processing engine in the AI technology. The so-called program processing engine is an engine that may be configured to develop an application program and display a virtual scene in the application program. For example, when the application program is an image display program, the program processing engine may be a graphics engine. For another example, when the application program is a game program, the program processing engine may be a game engine, such as an unreal engine (UE). The unreal engine has a plurality of versions, such as an unreal engine 4 (UE4) and an unreal engine 5 (UE5). A server of the program processing engine may be referred to as an engine server for short. When the program processing engine is the game engine such as the unreal engine, the engine server may be a UE dedicated server (UE DS). The UE DS may be configured to synchronize related information in a game with relatively high real time (for example, a first person shooter (FPS) game). A default network synchronization frame rate of the UE DS is 30 Hz (in other words, synchronization is performed for 30 times per second), which is also a default frame rate used by many online games. An arena battle game even uses a higher synchronization frequency, for example, usually 60 Hz or even 120 Hz.

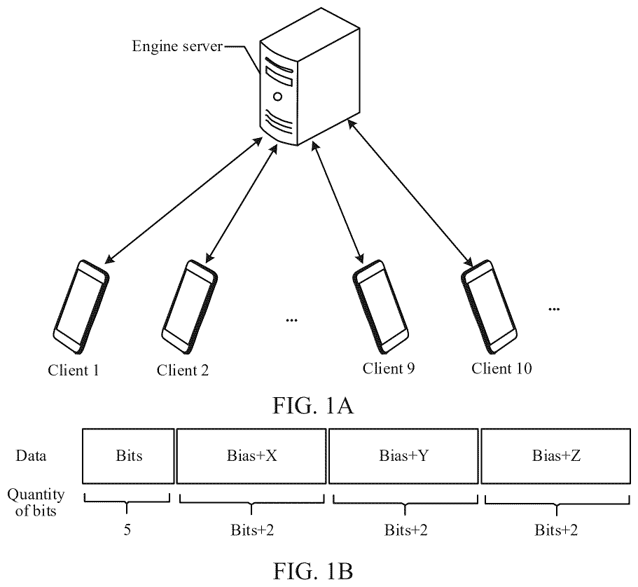

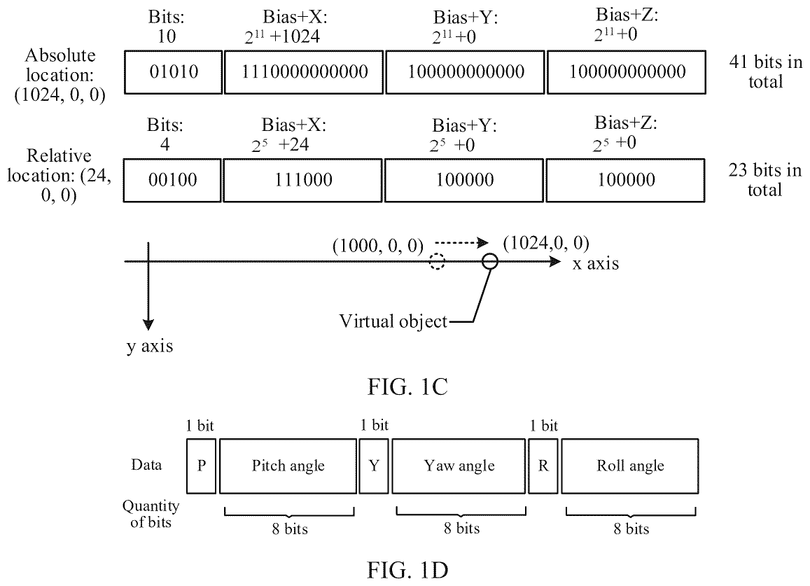

The engine server may provide one or more Actor Channels (communication channels configured to establish communication connections to clients, to perform information synchronization and management), and communicate with the corresponding clients based on the Actor Channels, as shown in FIG. 1A. In addition, in a property synchronization mechanism used by the engine server, a communication channel (or referred to as a connection) corresponding to each client is configured for collecting, at a particular frequency, a changed property list of a virtual object (Actor) in a virtual scene, and after the engine server performs serialization on the property list, the engine server synchronizes the property list to the client. Serialization is a process of converting an object into byte sequences, and the byte sequences may be transmitted on a network or saved in a local file. In the embodiments of this application, because different platforms and systems may use different programming languages and running environments, direct transmission of an object may cause a compatibility problem. Through the serialization, the object may be converted into a universal and platform-independent format, thereby ensuring that information between different platforms can be transmitted and parsed correctly.

The property list may include a plurality of properties (for example, a movement property, a style property, and a size property) of the Actor, and property information of the Actor under each property. During property synchronization, a bandwidth configured for synchronizing property information of the Actor under the movement property accounts for approximately half or even more of a total bandwidth. The property information of the Actor under the movement property may be FRepMovement (structure information). Information configured for synchronization in FRepMovement mainly includes: absolute pose information, an angular velocity, orientation information, and some flag values related to physics simulation. The absolute pose information at a moment mentioned herein is pose information determined based on a reference object at the moment, where the pose information may include a linear velocity (a velocity for short) and location information (a location for short). Correspondingly, the absolute pose information may include an absolute velocity and an absolute location. In addition, the orientation information mentioned herein may include the following rotation angles: a pitch angle (Pitch), a yaw angle (Yaw), a roll angle (Roll), and the like. Definitions of the information configured for synchronization in FRepMovement may be as follows:

/absolute velocity/
UPROPERTY (Transient)
FVector LinearVelocity;
/angular velocity/
UPROPERTY (Transient)
FVector AngularVelocity;
/absolute location/
UPROPERTY (Transient)
FVector Location;
/orientation information/
UPROPERTY (Transient)
FRotator Rotation; and
/whether the virtual object is in physics simulation/
UPROPERTY (Transient)
unit8 bRepPhysics: 1.

In the foregoing definitions, UPROPERTY is a macro, which may be configured for publishing a variable to an editor or a blueprint, allows the variable to be replicated and serialized, and may be accessed from the blueprint; and Transient may be configured for indicating that corresponding information is transient. A serialization mechanism is a specific method and process for implementing serialization, and there are many serialization mechanisms, for example, an FVector and an FRotator. The FVector is a serialization mechanism based on a three-dimensional vector structure, and the FRotator is a serialization mechanism based on a rotation angle. LinearVelocity, Angular Velocity, Location, and Rotation are all fields for storing information. Based on this, “FVector Linear Velocity” in the foregoing code refers to performing serialization on the absolute velocity in the Linear Velocity field by using the FVector; “FVector Angular Velocity” refers to performing serialization on the angular velocity in the AngularVelocity field by using the serialization mechanism FVector; “FVector Location” refers to performing serialization on the absolute location in the Location field by using the serialization mechanism FVector; “FRotator Rotation” refers to performing serialization on the orientation information in the Rotation field by using the serialization mechanism FRotator; and “unit8 bRepPhysics: 1” means that when the virtual object is in the physics simulation, a value of the flag bRepPhysics is 1.

A data volume required for synchronizing the property information of the Actor under the movement property depends on an actual size of data obtained through serialization. It can be known based on the foregoing definitions that, a serialization operation performed for the property information of the virtual object under the movement property mainly relates to two serialization mechanisms: the FVector and the FRotator. Therefore, in the embodiments of this application, a value change characteristic analysis is performed on the two serialization mechanisms, to improve a manner of synchronizing the property information of the Actor under the movement property according to an analyzed value change characteristic of each serialization mechanism. Details are as follows:

(1) Referring to FIG. 1B, a serialized format of the FVector may specifically include the following fields:
a Bits field, configured for storing a value, where the stored value is configured for indicating a quantity of bits required by a maximum value in absolute values of X, Y, and Z, or a maximum quantity of bits set by the program processing engine; at a default centimeter precision, the maximum quantity of bits set by the program processing engine (for example, the UE) may be that 24-1-23; X, Y, and Z all indicate coordinate values converted into integers, and the coordinate values are in cm, or may be enlarged according to different precision requirements; and FIG. 1B is described by using an example in which a quantity of bits occupied by the Bits field is 5;
a Bias+X field, configured for storing a result obtained by performing a Bias operation on X, where a quantity of bits occupied by the Bias+X field is Bits+2;
a Bias+Y field, configured for storing a result obtained by performing a Bias operation on Y, where a quantity of bits occupied by the Bias+Y field is Bits+2; and
a Bias+Z field, configured for storing a result obtained by performing a Bias operation on Z, where a quantity of bits occupied by the Bias+Z field is Bits+2.

The Bias operation mentioned above may be indicated as 1<< (Bits+1), and may be specifically an operation in which each bit in a binary system of a corresponding value is moved leftward by (Bits+1) bits and 0 is complemented at a last bit. In addition, Bits indicates the quantity of bits required by the maximum value in the absolute values of X, Y, and Z, and a specific formula of Bits is as follows:
Clamp (┌log₂(1+max (|X|,|Y|,|Z|))┐, 1, MaxBits)−1. MaxBits is an additionally set maximum quantity of bits, Clamp is a function of mapping a value of
┌log₂(1+max (|X|,|Y|,|Z|))┐ to be between 1 and MaxBits, and ┌*┐ indicates to perform a round-up operation on *, for example, if a value of log₂(1+max (|X|, |Y|, |Z|)) is 3.1, a value of ┌log₂(1+max (|X|,|Y|,|Z|)┐ is 4.

It can be known from the foregoing descriptions that, the absolute location of the virtual object corresponds to the Location field in FRepMovement, and is serialized by using the FVector. For the absolute location, the FVector may mainly include three floating-point fields: X, Y, and Z. In addition, it can be seen from the serialized format used by the FVector shown in FIG. 1B that, when serialization is performed on the absolute location by using the FVector, absolute values of coordinate values or distances to an origin affect a data length of data obtained through serialization:

\textcircled{1} It is assumed that x is 1000 m or more, for example, x=2¹⁷=131072 cm, and an absolute value of x is greater than absolute values of y and z. In this case, the data length of the data obtained by performing serialization on the absolute location is 62 bits (5+19+19+19-62).

\textcircled{2} It is assumed that x is approximately 10 m, for example, x=2¹⁰=1024 cm, and an absolute value of x is greater than absolute values of y and z. In this case, the data length of the data obtained by performing serialization on the absolute location is 41 bits (5+12+12+12=41).

\textcircled{3} It is assumed that x is approximately 1 m, for example, x=2⁷=128 cm, and an absolute value of x is greater than absolute values of y and z. In this case, the data length of the data obtained by performing serialization on the absolute location is 32 bits (5+9+9+9=32).

Based on this, in the embodiments of this application, a value of a relative location (that is, a difference between absolute locations collected at two adjacent moments) is usually less than a value of the absolute location. Therefore, in the embodiments of this application, the following idea is provided for the location information: During synchronization of the location information, synchronization of the absolute location may be changed to synchronization of the relative location, so that a quantity of bits required by data obtained by performing serialization on the relative location is much less (that is, a data volume is much less) than a quantity of bits required by the data obtained by performing serialization on the absolute location. In this way, a data volume for location synchronization is greatly reduced through algorithm optimization, without affecting movement synchronization experience, thereby effectively reducing bandwidth costs. Further, to prove feasibility of the idea, the embodiments of this application further performs the following tests:

For example, the Actor is an object such as a game character, the Actor moves at a common velocity such as 6 m/s, and a location synchronization frequency of the engine server is 30 Hz. In this case, a location change distance of the Actor in each frame of image is approximately 20 cm (on a horizontal plane). For example, a circle is used to indicate the Actor. Referring to FIG. 1C, the Actor moves from (1000, 0, 0) to (1024, 0, 0) in a game picture, in other words, after the movement, an absolute location is (1024, 0, 0), and a relative location is (24, 0, 0). In this case, according to the descriptions of the fields in the FVector, the following calculations may be performed according to the absolute location: ┌log₂(1+1024)┐−1=10, and 5+(10+2)+(10+2)+(10+2)=41; and the following calculations may be performed according to the relative location: ┌log₂(1+24)┐−1=4, and 5+ (4+2)+ (4+2)+ (4+2)=23. It can be learned that, data obtained by performing serialization on the absolute location (1024, 0, 0) needs 41 bits, and data obtained by performing serialization on the relative location (24, 0, 0) needs only 23 bits.

For another example, the Actor is an object such as an automobile, the Actor moves at 120 km/h, and a location synchronization frequency of the engine server is 30 Hz. In this case, a location change of the Actor in each frame of image is approximately 111 cm. Because ┌log₂(1+111)┐−1=6, it may be calculated that 5+(6+2)+(6+2)+(6+2)=29, that is, data obtained by performing serialization on the relative location needs only 29 bits. In other words, in this case, when synchronization is performed by using the relative location, the data thereof needs only 29 bits.

In conclusion, according to the idea of synchronizing the relative location provided in the embodiments of this application, a data length of data obtained by performing serialization on a location can be effectively reduced. In addition, the data length is positively correlated with a data volume. Therefore, it can be known that, if the relative location is synchronized, less data can be used during the synchronization, and the data length is irrelevant to the value of the absolute location, thereby effectively reducing bandwidth costs.

It can be known from the foregoing descriptions that, the absolute velocity of the virtual object corresponds to the LinearVelocity field in FRepMovement, and is serialized by using the FVector. Therefore, similar to the absolute location, in the embodiments of this application, the following idea is also provided for velocity information: During synchronization of the velocity information, synchronization of the absolute velocity is replaced with synchronization of a relative velocity. When the Actor moves in a direction, a velocity of the Actor in several consecutive frames usually does not change or changes little. Therefore, a value of the relative velocity is usually less than a value of the absolute velocity, and in this case, a quantity of bits required by data obtained by performing serialization on the relative location is much less than a quantity of bits required by data obtained by performing serialization on the absolute location. In this way, a data volume for location synchronization is greatly reduced through algorithm optimization, without affecting movement synchronization experience, thereby effectively reducing bandwidth costs.

(2) Referring to FIG. 1D, a serialized format of the FRotator may specifically include the following fields:

A Pitch (pitch angle) field is configured for storing the pitch angle of the virtual object, that is, an angle by which the virtual object rotates around an X axis, for example, an angle when a head of the virtual object rotates upward or downward.

A Yaw (yaw angle) field is configured for storing the yaw angle of the virtual object, that is, an angle by which the virtual object rotates around a Z axis, for example, an angle when the head of the virtual object rotates leftward or rightward.

A Roll (roll angle) field is configured for storing the roll angle of the virtual object, that is, an angle by which the virtual object rotates around a Y axis, for example, an angle when the head of the virtual object obliquely rotates leftward or rightward.

A P field (first field) is configured for storing a value, where the stored value is configured for indicating whether the pitch angle needs to be written into the Pitch field; and when the stored value is an invalid value (for example, a value 0), it indicates that the pitch angle is not written into the Pitch field.

A Y field (second field) is configured for storing a value, where the stored value is configured for indicating whether the yaw angle needs to be written into the Yaw field; and when the stored value is an invalid value (for example, a value 0), it indicates that the yaw angle is not written into the Yaw field.

An R field (third field) is configured for storing a value, where the stored value is configured for indicating whether the roll angle needs to be written into the Roll field; and when the stored value is an invalid value (for example, a value 0), it indicates that the roll angle is not written into the Roll field.

In the embodiments of this application, when the pitch angle, the yaw angle, and the roll angle are stored, values obtained by mapping integer values of the angles from [0, 360) to [0, 256) each may be stored. In this case, the Pitch field, the Yaw field, and the Roll field each occupy one byte (that is, 8 bits). Certainly, two bytes or more bytes may alternatively be configured for storing the three angles, so that the three angles have higher precision.

It can be known from the foregoing descriptions that, the orientation information of the virtual object corresponds to the Rotation field in FRepMovement, and is serialized by using the FRotator. In addition, it can be seen from the serialized format used by the FRotator shown in FIG. 1D that, when serialization is performed on the orientation information by using the FRotator, a quantity of rotation angles in the orientation information affects a data length of data obtained through serialization. In addition, researches have shown that, for most virtual scenes, two rotation angles: Pitch and Roll of the Actor are both zero at most of time. Therefore, in the embodiments of this application, the following idea is provided for the orientation information: During synchronization of the orientation information, only the rotation angle Yaw on the horizontal plane needs to be synchronized, and because an integer value of the angle is mapped from [0, 360) to [0, 256), synchronization of the Yaw needs only one byte. Further, when the Actor moves in a direction, the Yaw of the Actor in several consecutive frames may not change. In this case, in the embodiments of this application, a flag bit may further be added. In this way, when a Yaw of the virtual object at a current moment is the same as a Yaw synchronized at a previous moment, only the flag bit needs to be set, and Yaw data is not written, to further reduce a data volume required during the synchronization of the orientation information, thereby further reducing bandwidth costs, and improving synchronization efficiency.

Based on the foregoing descriptions, an embodiment of this application provides an information synchronization method in which bandwidth costs are reduced based on relative pose information of a virtual object. During specific implementation, the information synchronization method may be performed by a computer device. The computer device may be the foregoing engine server; or the computer device may include an engine server and a terminal with relatively good performance together, to reduce running pressure of the engine server.

The engine server mentioned herein may be an independent physical server, or may be a server cluster or a distributed system formed by a plurality of physical servers, or may be a cloud server that provides a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform. The terminal that collaborates with the engine server to perform the information synchronization method may include, but is not limited to: a smart phone, a computer (such as a tablet computer, a laptop computer, or a desktop computer), a smart wearable device (such as a smart watch, or smart glasses), a smart voice interaction device, a smart home appliance (such as a smart TV), an in-vehicle terminal, an aircraft, or the like.

In addition, the terminal and the engine server may be located outside a blockchain network, or may be located inside the blockchain network, which are not limited herein. The so-called blockchain network is a network formed by a peer-to-peer network and a blockchain. The blockchain is a new application mode of computer technologies such as distributed data storage, peer-to-peer transmission, a consensus mechanism, and an encryption algorithm. The blockchain is essentially a decentralized database and is a string of data blocks (or referred to as blocks) generated through association by using a cryptographic method. When any device of the terminal and the engine server is located in the blockchain network, or has a communication connection with the blockchain network, the any device may upload internal data to a blockchain of the blockchain network for storage, to prevent internal data of the engine server from being tampered with, thereby improving security of the internal data.

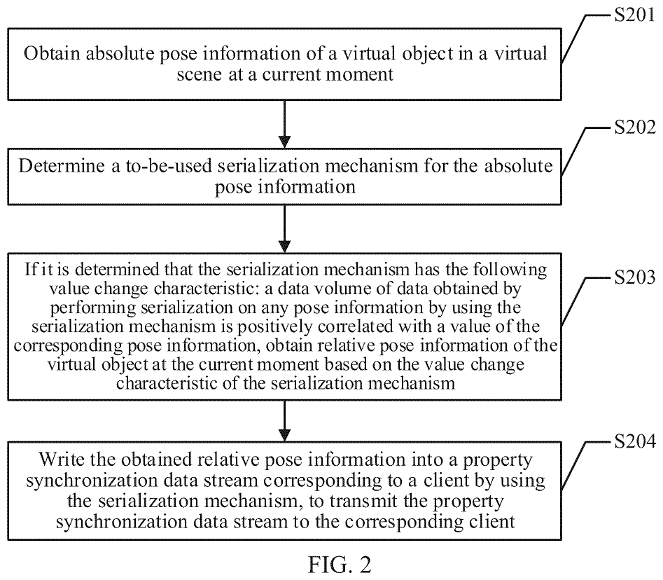

For ease of description, by using an example in which the engine server independently performs the information synchronization method, the information synchronization method provided in this embodiment of this application is described below with reference to a flowchart shown in FIG. 2. Referring to FIG. 2, the information synchronization method may include the following S201 to S204.

S201: Obtain absolute pose information of a virtual object in a virtual scene at a current moment.

In this embodiment of this application, the virtual scene may be understood as a scene that may be displayed on a screen of a device. Specifically, the virtual scene may be a scene obtained by simulating a scene in the real world, for example, a scene obtained by simulating an autonomous driving scene or a scenic resort visit scene in the real world; or the virtual scene may be a semi-simulated semi-fictional scene, for example, a scene in which fictional characters are superimposed in a simulated world corresponding to the real world; or the virtual scene may be a pure fictional scene, for example, a game scene, a scene in a television drama, or a scene in a movie.

The virtual scene may include at least one virtual object (Actor). The so-called virtual object may be a movable object in the virtual scene, such as a virtual character in the game scene or a virtual animal in the game scene; or the virtual object may be a static object element in a virtual scene, such as a virtual lawn or a virtual building. Each virtual object in the virtual scene may be a movable object, or may include both a static object element and a movable object, which is not limited herein. In addition, the virtual object described in S201 and subsequent operations in this embodiment of this application may be any virtual object in the virtual scene. The virtual object may have a plurality of properties (for example, a movement property, a style property, and a size property), and property information of the virtual object under each property. Property information of the virtual object under the movement property may include absolute pose information, orientation information, and the like. Property information of the virtual object under the style property may include a shape, an appearance color, and the like. Property information of the virtual object under the size property may include a size value.

Absolute pose information of the virtual object at any moment is stored in FRepMovement (namely, the property information under the movement property) of the virtual object (namely, the Actor). Therefore, when performing S201, the engine server may search local space for FRepMovement of the Actor at the current moment, to obtain the absolute pose information of the virtual object at the current moment from found FRepMovement. FRepMovement of the Actor at the current moment may be stored in a property list of the virtual object at the current moment, and the property list includes the plurality of properties of the virtual object and the property information of the virtual object under each property. In this case, when the engine server obtains FRepMovement of the Actor from the local space, the engine server may obtain the property list of the virtual object at the current moment, and find the movement property from the obtained property list, to obtain the absolute pose information of the virtual object at the current moment from the property information corresponding to the movement property in the property list. The absolute pose information at the current moment is pose information determined based on a reference object at the current moment, and the pose information is synchronized to a client in a serialization manner.

The absolute pose information of the virtual object at the current moment may include: an absolute velocity of the virtual object at the current moment (that is, a velocity determined based on the reference object at the current moment), and an absolute location of the virtual object at the current moment (that is, a location determined based on the reference object at the current moment). In a possible implementation, if the engine server performs an information synchronization operation after it is detected each time that the property information of the virtual object changes, the current moment mentioned herein may be a moment at which it is detected that the property list of the virtual object changes, or a moment at which it is detected that the absolute pose information of the virtual object changes. In another possible implementation, if the engine server periodically performs an information synchronization operation, that is, performs the information synchronization operation at a particular synchronization frequency, the current moment mentioned herein may be a moment at which the information synchronization operation needs to be performed that is determined according to the synchronization frequency. For example, assuming that the synchronization frequency is a frequency of synchronization once every Is, and the engine server performs the information synchronization operation at 10:25:26, the current moment is 10:25:27.

S202: Determine a serialization mechanism for the absolute pose information.

It can be known from a property synchronization mechanism of the foregoing engine server that, any pose information needs to be synchronized to the client in the serialization manner. To be specific, during synchronization of any pose information, the engine server needs to perform serialization processing on the any pose information, to synchronize data obtained through the serialization processing to the client. Based on this, after obtaining the absolute pose information of the virtual object at the current moment in S201, the engine server may determine, in S202, the serialization mechanism for the absolute pose information. It can be known from the foregoing descriptions that, the serialization mechanism used by the engine server for the absolute pose information may be an FVector (that is, a serialization mechanism based on a three-dimensional vector structure).

S203: If it is determined that the serialization mechanism has the following value change characteristic: a data volume of data obtained by performing serialization on any pose information by using the serialization mechanism is positively correlated with a value of the corresponding pose information, obtain relative pose information of the virtual object at the current moment based on the value change characteristic of the serialization mechanism.

The value change characteristic may be a characteristic that other information may change when the value of the pose information changes. For example, when the value of the pose information changes, the data volume of the data obtained through serialization may change. There may be a plurality of serialization mechanisms, and different serialization mechanisms may have different value change characteristics. Some serialization mechanisms may have the following value change characteristic: a data volume of data obtained by performing serialization on any pose information by using the serialization mechanism is positively correlated with a value of the corresponding pose information. In other words, a larger value of the serialized pose information indicates a larger data volume of the data obtained through the serialization. For example, when the serialization mechanism is the FVector, the FVector has the foregoing value change characteristic.

It can be known based on the value change characteristic of the serialization mechanism that, a larger value of the serialized pose information indicates a larger data volume of the data obtained through the serialization; and a smaller value of the serialized pose information indicates a smaller data volume of the data obtained through the serialization. A value of the relative pose information of the virtual object is usually less than a value of the absolute pose information of the virtual object. Therefore, the engine server may obtain the relative pose information of the virtual object at the current moment based on the value change characteristic of the serialization mechanism, to change serialization of the absolute pose information to serialization of the relative pose information, to reduce the data volume obtained through the serialization.

The obtained relative pose information is configured for reflecting a difference between the absolute pose information of the virtual object at the current moment and absolute pose information of the virtual object at a previous moment, and the absolute pose information at the previous moment is pose information determined based on the reference object at the previous moment.

In this embodiment of this application, the absolute pose information may include different parameters reflecting poses. For example, the absolute pose information may include the absolute location. When the absolute pose information includes the absolute location, the obtained relative pose information may include a relative location of the virtual object at the current moment, and the relative location may be obtained by calculating a difference between the absolute location of the virtual object at the current moment and an absolute location of the virtual object at the previous moment. For another example, the absolute pose information may include the absolute velocity. When the absolute pose information includes the absolute velocity, the obtained relative pose information may include a relative velocity of the virtual object at the current moment, and the relative velocity may be obtained by calculating a difference between the absolute velocity of the virtual object at the current moment and an absolute velocity of the virtual object at the previous moment. When performing S203, the engine server may calculate, in real time, the relative pose information of the virtual object at the current moment according to the absolute pose information of the virtual object at the current moment and the absolute pose information of the virtual object at the previous moment; or may obtain the relative pose information of the virtual object at the current moment from to-be-processed property information (FRepRelativeMovement, structure information) of the virtual object. The to-be-processed property information may be generated by the engine server or another device before S203 is performed. The to-be-processed property information may further include a yaw angle of the virtual object at the current moment, and does not include a pitch angle and a roll angle of the virtual object at the current moment.

In a possible implementation, after determining the serialization mechanism in S202, the engine server may directly perform S203 to obtain the relative pose information of the virtual object at the current moment, thereby implementing synchronization of the relative pose information through subsequent S204. In another possible implementation, the virtual object may be in different statuses, and when the virtual object is in different statuses, impact of the relative pose information on reduction of a synchronized data volume and bandwidth costs may be different. When the relative pose information is synchronized in some statuses, the synchronized data volume and the bandwidth costs can be better reduced. Based on this, in this embodiment of this application, to avoid introducing an additional error and excessive calculations, thereby better reducing the synchronized data volume and the bandwidth costs, a status condition that the virtual object is required to have when the relative pose information is used may be set. In this way, before performing S203, the engine server needs to first obtain status information of the virtual object at the current moment, and determine the status condition that the virtual object is required to have when the relative pose information of the virtual object at the current moment is used. It can be known from the foregoing descriptions that, the status information may be located in a related field in FRepMovement of the virtual object. Therefore, the engine server may obtain the status information of the virtual object at the current moment from FRepMovement of the virtual object. Then, the engine server may determine, according to the status information, whether the virtual object has the status condition. If it is determined, according to the status information, that the virtual object has the status condition, S203 is triggered to be performed. If it is determined, according to the status information, that the virtual object does not have the status condition, the absolute pose information of the virtual object at the current moment is written into a property synchronization data stream corresponding to the client by using the serialization mechanism.

The status information is configured for indicating a status of the virtual object at the current moment, for example, indicating whether the virtual object is attached to another virtual object, or indicating whether the virtual object is in physics simulation.

Through the foregoing method, S203 may be performed only when the virtual object has the status condition, to avoid introducing an additional error and excessive calculations, thereby better reducing the synchronized data volume and the bandwidth costs.

It is further proved that, in this embodiment of this application, it is assumed that the relative pose information of the virtual object at the current moment includes at least one of the following: a relative velocity and a relative location. In this case, when the virtual object is in the following statuses, synchronization by using the relative pose information introduces an additional error and excessive calculations: (1) The virtual object is attached to another virtual object, for example, the virtual object such as a game character is attached to a virtual object such as a horse, in other words, the game character is in a horse riding state. This is because a relative pose of the virtual object at two moments exists and a relative pose between the virtual object and the another virtual object at the current moment also exists. 2) The virtual object is in the physics simulation. This is because during the physics simulation, a movement of the Actor is additionally controlled by a physical system. Based on this, the status condition may be set to include at least one of the following: the virtual object is not attached to another virtual object, and the virtual object is not in the physics simulation. Correspondingly, the status information includes at least one of the following: a status identifier configured for indicating whether the virtual object is attached to the another virtual object and a status identifier configured for indicating whether the virtual object is in the physics simulation.

In a possible implementation, in this embodiment of this application, if the obtained relative pose information is set to be located in the to-be-processed property information of the virtual object, an implementation of subsequent S204 may include: writing, into the property synchronization data stream, the to-be-processed property information in which the obtained relative pose information is located. Because the to-be-processed property information includes the yaw angle (Yaw) of the virtual object at the current moment, and does not include the pitch angle (Pitch) and the roll angle (Roll) of the virtual object at the current moment, when the Pitch and the Roll of the virtual object are non-zero, an additional error is introduced when synchronization is performed by using the to-be-processed property information. Therefore, the status condition may further be set to include that the pitch angle and the roll angle of the virtual object at the current moment are zero. Correspondingly, the status information may further include orientation information of the virtual object, and the orientation information includes the yaw angle, the pitch angle, and the roll angle of the virtual object at the current moment.

In this embodiment of this application, because it is learned through investigation that the virtual object has relatively short time in the foregoing statuses in an actual running process of most virtual scenes, synchronization may be performed by using the relative pose information by default. In other words, in this embodiment of this application, by default, the manner of performing synchronization by using relative pose information is applicable to the case in which the virtual object in the virtual scene has relatively short time in the foregoing statuses. However, some virtual scenes may not satisfy this case. Therefore, in this embodiment of this application, a global optimization function may further be set. The so-called global optimization function may also be referred to as a global optimization identifier, which is a function that can be supported by any virtual object in the virtual scene and that is for determining, by determining whether the virtual object has the status condition, whether to synchronize relative pose information of the corresponding virtual object. In this case, if the virtual scene does not conform to this case, the global optimization function may be disabled, and optimization is selectively enabled according to an object type of the virtual object.

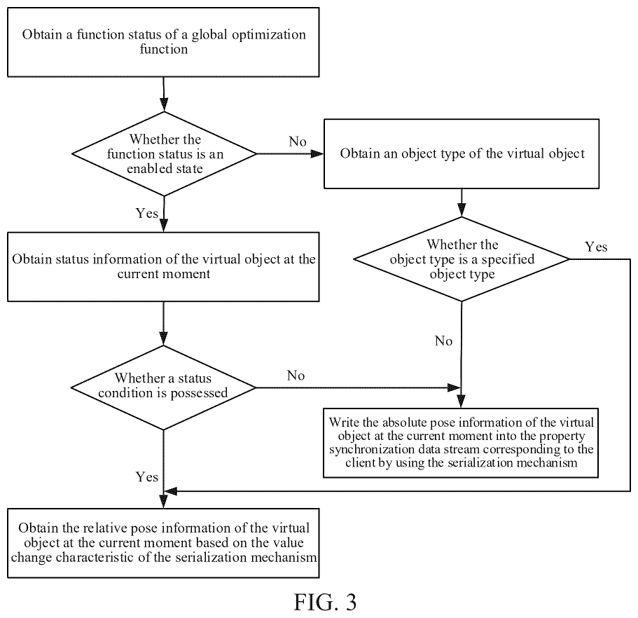

In this case, before obtaining the status information of the virtual object at the current moment, the engine server may first obtain a function status of the global optimization function, the function status including an enabled state or a disabled state; and if the function status of the global optimization function is the enabled state, the operation of obtaining, by the engine server, status information of the virtual object at the current moment is triggered to be performed; or if the function status of the global optimization function is the disabled state, an object type of the virtual object is obtained, and when the object type of the virtual object is a specified object type, the operation of obtaining relative pose information of the virtual object at the current moment based on the value change characteristic of the serialization mechanism is triggered to be performed. If the object type of the virtual object is not the specified object type, it indicates that a process of synchronizing the pose information of the virtual object is not optimized, in other words, information synchronization is performed by using the absolute pose information of the virtual object at the current moment. To be specific, if the object type of the virtual object is not the specified object type, the absolute pose information of the virtual object at the current moment is written into the property synchronization data stream corresponding to the client by using the serialization mechanism. For example, for processing logic used when the engine server in this case obtains the relative pose information of the virtual object at the current moment, reference may be made to FIG. 3.

S204: Write the obtained relative pose information into the property synchronization data stream corresponding to the client by using the serialization mechanism, to transmit the property synchronization data stream to the corresponding client.

In a possible implementation, after detecting an information synchronization requirement of the client, the engine server may write the relative pose information into the property synchronization data stream corresponding to the client in a manner of performing serialization on the relative pose information in real time. When the engine server intends to actively synchronize the relative pose information to the client, it may be considered that the client has the information synchronization requirement. Alternatively, when the engine server receives an information write request of a communication channel corresponding to the client, it may be considered that the client has the information synchronization requirement.

In this specific implementation, when performing S204, the engine server may perform serialization processing on the obtained relative pose information by using the serialization mechanism in response to the information synchronization requirement of the client, to obtain relative pose serialization data; and then write the relative pose serialization data into the property synchronization data stream corresponding to the client, to transmit the property synchronization data stream to the corresponding client. Through this implementation, there may be no need to consume memory space to pre-store the relative pose serialization data, thereby improving memory utilization and stability of the engine server.

In another specific implementation, researches show that both FRepMovement and FRepRelativeMovement belongs to information of a shared serialization type, the absolute pose information is located in FRepMovement, and the relative pose information is located in FRepRelativeMovement. Therefore, it can be known that any pose information belongs to the information of the shared serialization type. The so-called information of the shared serialization type is information having the following value change characteristic: Pose information in a same frame may be first serialized by using a method of FRepLayout::BuildSharedSerialization (that is, the method for performing serialization processing by using the serialization mechanism), and data obtained through the serialization may be buffered in local space of the engine server, so that when serialization data is written into a communication channel corresponding to another client, the serialization data may be directly read from shared serialization data buffered in the local space. Based on this, after obtaining the relative pose information in S203, the engine server may perform serialization processing on the obtained relative pose information by using the serialization mechanism, to obtain the relative pose serialization data, and buffer the relative pose serialization data in the local space.

In this specific implementation, when performing S204, the engine server may read the relative pose serialization data from the local space in response to the information synchronization requirement of the client, and write the relative pose serialization data into the property synchronization data stream corresponding to the client. Through this implementation, when the engine server needs to synchronize the relative pose information to a plurality of clients, the serialization operation is performed on the relative pose information only once, which can effectively reduce processing resources. In addition, the relative pose serialization data is buffered, so that when the information synchronization requirement of the client is detected, the relative pose serialization data may be quickly written into the property synchronization data stream, to quickly transmit the property synchronization data stream to the corresponding client, thereby improving synchronization efficiency of pose information.

In this embodiment of this application, a value change characteristic analysis may be performed on a serialization mechanism for absolute pose information, and it is learned that the serialization mechanism has the following value change characteristic: a data volume of data obtained by performing serialization on any pose information by using the serialization mechanism is positively correlated with a value of the corresponding pose information. In this way, after absolute pose information of a virtual object in a virtual scene at a current moment is obtained, relative pose information of the virtual object at the current moment may be obtained by considering the value change characteristic of the serialization mechanism. Because the obtained relative pose information is configured for indicating a difference between the absolute pose information of the virtual object at the current moment and absolute pose information of the virtual object at a previous moment, a value of the relative pose information is much less than a value of the absolute pose information, and particularly, when a difference between absolute pose information at two adjacent moments is relatively small, the value of the relative pose information may be a very small value. In this case, compared with serialization of an absolute pose, the relative pose information is written into a property synchronization data stream by using the serialization mechanism, which can effectively reduce a data volume for pose synchronization, thereby effectively reducing bandwidth costs, and improving synchronization efficiency of pose information.

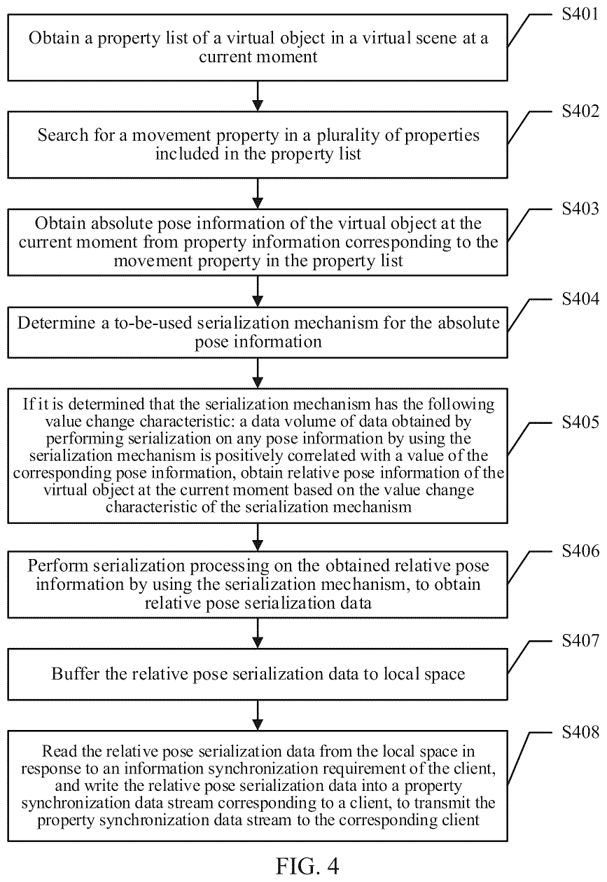

Based on the related descriptions of the method embodiment shown in FIG. 2, an embodiment of this application further provides an information synchronization method. This embodiment of this application is still described by using an example in which an engine server independently performs the information synchronization method. Referring to FIG. 4, the information synchronization method may include the following S401 to S408.

S401: Obtain a property list of a virtual object in a virtual scene at a current moment.

The property list includes a plurality of properties of the virtual object and property information of the virtual object under each property. The plurality of properties may include, but is not limited to, a movement property, a style property, a size property, and the like. Property information of the virtual object under the movement property includes absolute pose information. Property information of the virtual object under the style property includes a shape, an appearance color, and the like. Property information of the virtual object under the size property may include a size value. In addition, for any changed property information, an entire process of writing the property information into a property synchronization data stream configured for synchronization may be processed in a method of FRepLayout::SendProperties_r (that is, a method for writing property information).

In a possible implementation, if the engine server performs an information synchronization operation each time after it is detected each time that the property list of the virtual object changes, the property list obtained in S401 is essentially a changed property list, to be specific, property information under at least one property in the property list is different from property information of a corresponding property generated by the virtual object at a previous moment. The changed property list may be determined through object memory snapshot comparison (that is, comparing a current property list with a property list stored in a memory snapshot), or may be determined through pushing mode marking, which is not limited herein. In another possible implementation, if the engine server performs an information synchronization operation at a particular synchronization frequency, the property list obtained in S401 may be a changed property list, or may be an unchanged property list, which is not limited herein.

S402: Search for the movement property in the plurality of properties included in the property list.

It can be known from the foregoing descriptions that, the absolute pose information is located in FRepMovement (that is, the property information of the virtual object under the movement property), and FRepMovement belongs to property information of a shared serialization type. When the engine server processes the property information of the shared serialization type, a property type of a property corresponding to the property information is ERepLayoutCmdType::RepMovement (referred to as a reference property type). Therefore, it can be seen that, when a property type of a property is ERepLayoutCmdType::RepMovement, it may be considered that the property is the movement property.

Based on this, when performing S402, the engine server may determine the reference property type, a property under the reference property type being the movement property; sequentially traverse the properties in the property list, and obtain a property type of a currently traversed property; compare the obtained property type with the reference property type; and if the obtained property type is the same as the reference property type, determine that the currently traversed property is the movement property; or if the obtained property type is different from the reference property type, continuously perform traversing, until the properties in the property list are traversed.

S403: Obtain absolute pose information of the virtual object at the current moment from the property information corresponding to the movement property in the property list.

S404: Determine a serialization mechanism for the absolute pose information.

S405: If it is determined that the serialization mechanism has the following value change characteristic: a data volume of data obtained by performing serialization on any pose information by using the serialization mechanism is positively correlated with a value of the corresponding pose information, obtain relative pose information of the virtual object at the current moment based on the value change characteristic of the serialization mechanism.

S406: Perform serialization processing on the obtained relative pose information by using the serialization mechanism, to obtain relative pose serialization data.

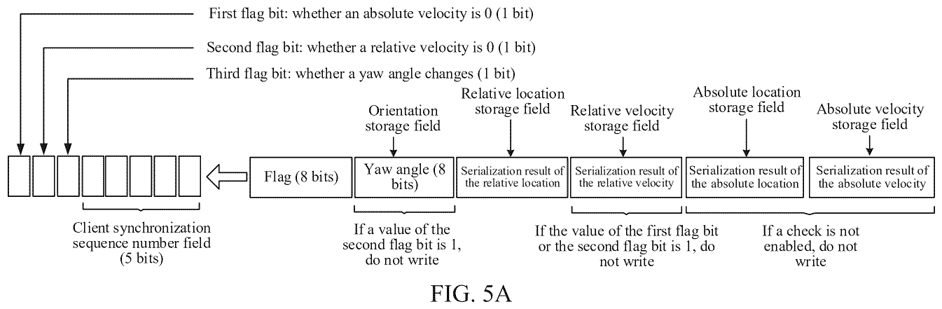

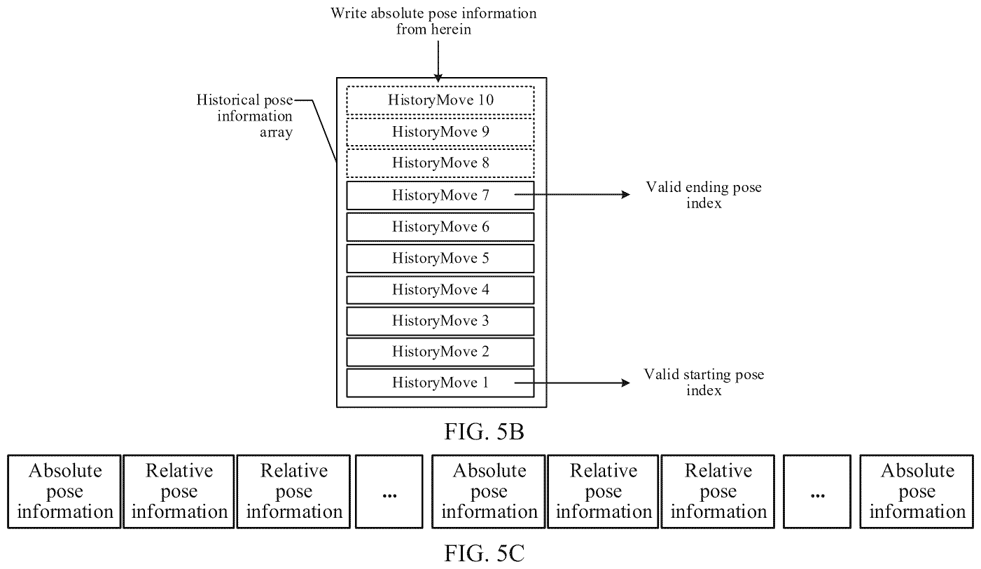

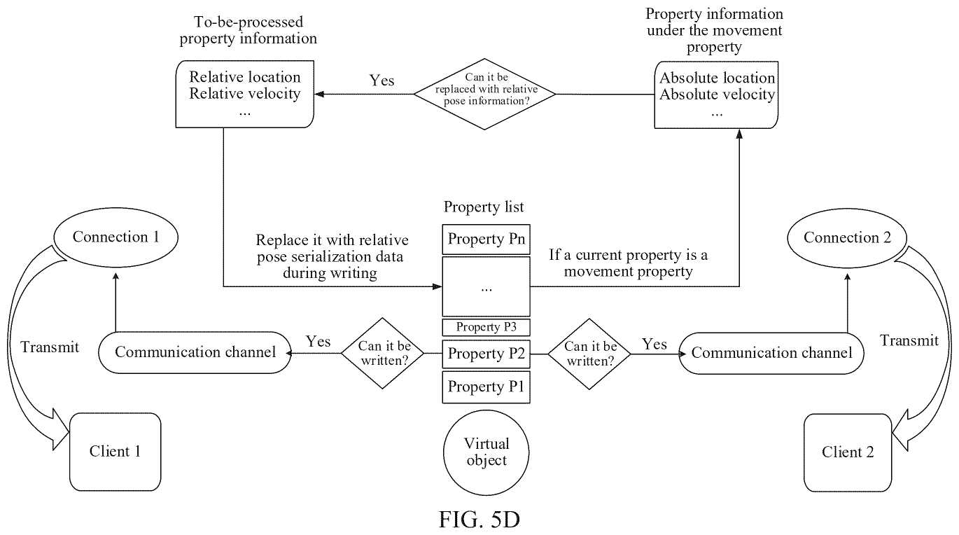

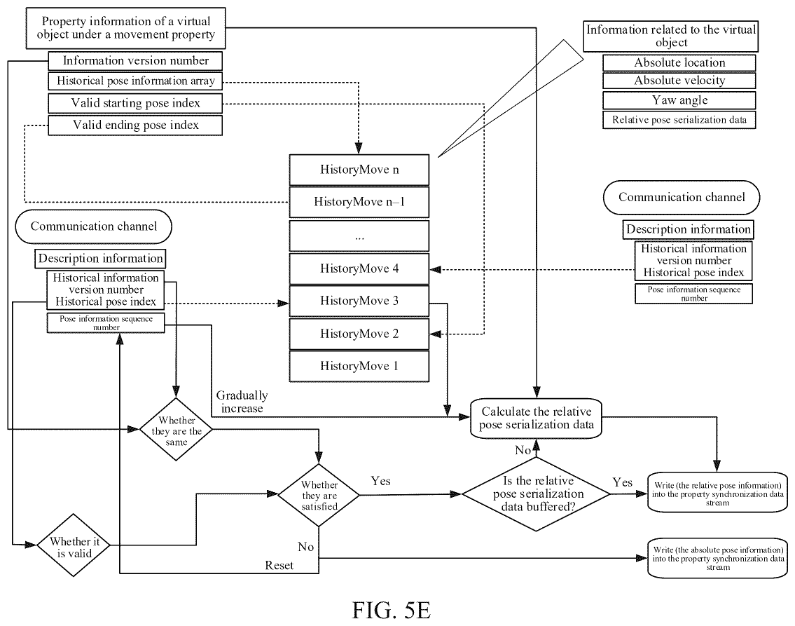

In this embodiment of this application, an entirely new serialized data format is provided for the relative pose information. As shown in FIG. 5A, the entirely new serialized data format may include at least one of the following fields:

A first flag bit (indicated by a Flag 1) may also be referred to as a static flag bit. A value of the first flag bit may be determined according to whether an absolute velocity is zero. When the value of the first flag bit is a valid value (for example, a value 1), it indicates that the absolute velocity is zero. During parsing, if the value of the field read by a client is the valid value (for example, the value 1), the absolute velocity may be directly set to FVector (0, 0, 0). It can be seen that, through setting of the first flag bit, the following problem can be effectively avoided: When the virtual object in the engine server is static, the absolute velocity calculated by the client by using a relative velocity has an error, and is still a relatively small non-zero velocity value. In an actual application, a quantity of bits occupied by the field is one bit.

A second flag bit (indicated by a Flag 2) may also be referred to as an absolute velocity-invariant flag bit. A value of the second flag bit may be determined according to whether the relative velocity is zero. When the value of the second flag bit is a valid value (for example, the value 1), it indicates that the relative velocity is zero. In other words, the absolute velocity in current synchronization does not change compared with an absolute velocity in previous synchronization, and the relative velocity does not need to be written subsequently. During parsing, if the value of the field read by the client is the valid value (for example, the value 1), a current linear velocity (namely, the absolute velocity) may not be updated. It can be seen that, through setting of the second flag bit, when the relative velocity is zero, whether the client needs to update the absolute velocity can be efficiently indicated by using the value of the second flag bit, thereby improving processing efficiency at a client side. In an actual application, a quantity of bits occupied by the field is one bit.

A third flag bit (indicated by a Flag 3) may also be referred to as a Yaw-invariant flag bit. A value of the third flag bit may be determined according to whether a yaw angle (Yaw) of the virtual object changes. When the value of the third flag bit is a valid value (for example, the value 1), it indicates that the yaw angle (Yaw) in the current synchronization does not change compared with a Yaw in the previous synchronization. During parsing, if the value of the field read by the client is the valid value (for example, the value 1), the current Yaw may not be updated. It can be seen that, through setting of the third flag bit, when the Yaw does not change, whether the client needs to update the Yaw can be efficiently indicated by using the value of the third flag bit, thereby improving processing efficiency at the client side. In an actual application, a quantity of bits occupied by the field is one bit.

A client synchronization sequence number field is configured for storing a pose information sequence number. The pose information sequence number is configured for indicating a quantity of times of continuously using the relative pose information of the virtual object to perform information synchronization. In addition, a maximum value allowed to be filled in the field may indicate a quantity-of-times threshold for which the relative pose information is allowed to be continuously used to perform information synchronization, and the maximum value allowed to be filled in the field may be determined according to a quantity of bits occupied by the field. In an actual application, the quantity of bits occupied by the field may be set according to a service requirement. For example, the field may be set to occupy five bits. In this case, it indicates that the maximum value allowed to be filled in the field is 32. In other words, in this case, it may be restricted that the quantity of times of continuously using the relative pose information to perform information synchronization does not exceed 32, thereby avoiding an excessively large accumulated error calculated by the client side.

An orientation storage field is configured for storing the yaw angle. When the yaw angle is stored, a value obtained by mapping an integer value of the yaw angle from [0, 360) to [0, 256) needs to be stored. When the value of the third flag bit indicates that the yaw angle of the virtual object at the current moment does not change, the yaw angle is not written into the orientation storage field, in other words, the orientation storage field is null. In an actual application, a quantity of bits occupied by the field is one bit.

A relative location storage field is configured for storing a serialization result of the relative location, that is, storing FVector serialization data of the relative location configured for indicating that the absolute location changes.

A relative velocity storage field is configured for storing a serialization result of the relative velocity, that is, storing FVector serialization data of the relative velocity configured for indicating that the absolute velocity changes. When the value of the Flag 1 (first flag bit) or the Flag 2 (second flag bit) is the valid value (for example, the value 1), the relative velocity is not written into the field. In other words, when the value of the first flag bit indicates that an absolute velocity of the virtual object at the current moment is zero, or when the value of the second flag bit indicates that a relative velocity of the virtual object at the current moment is zero, the relative velocity storage field is null.

An absolute pose storage field is configured for storing a serialization result of the absolute pose information.

It can be known from the foregoing descriptions that, the virtual scene is presented through an application program. In this case, to ensure accuracy of information synchronization by using the relative pose information, in this embodiment of this application, it may be set that the application program is configured with a synchronization optimization function. The so-called synchronization optimization function is a function of performing data synchronization by using the relative pose information. In addition, a check mode is set for the synchronization optimization function. The so-called check mode is a mode of checking, by using the absolute pose information, whether the relative pose information is accurate. Through this operation, before the synchronization optimization function is online, an accuracy check is performed on the synchronization optimization function of the application program by using the check mode, to ensure reliability of the subsequent synchronization optimization function. Based on this, in this embodiment of this application, the following content may be set: If the synchronization optimization function is in a test phase and the check mode is enabled, during filling of the serialized data format, the absolute pose storage field is required to be filled with the serialization result of the absolute pose information of the virtual object at the current moment; and if the synchronization optimization function is in the test phase and the check mode is not enabled, or if the synchronization optimization function is in an application phase, during the filling of the serialized data format, the absolute pose information is not written into the absolute pose storage field, in other words, the absolute pose storage field is null.

In a possible implementation, the absolute pose storage field may be subdivided into an absolute location storage field and an absolute velocity storage field. The absolute location storage field is configured for storing a serialization result of the absolute location (that is, FVector serialized data of the absolute location), and the absolute location is written into the absolute location storage field only when the check mode for the synchronization optimization function of the application program is enabled. Similarly, the absolute velocity storage field is configured for storing a serialization result of the absolute velocity (that is, FVector serialization data of the absolute velocity), and the absolute velocity is written into the absolute velocity storage field only when the check mode for the synchronization optimization function of the application program is enabled.

Based on the foregoing descriptions related to the serialized data format, when performing S406, the engine server may obtain the serialized data format, and fill the at least one field in the serialized data format according to the serialization mechanism and the obtained relative pose information, to obtain the relative pose serialization data.

When the relative pose information of the virtual object at the current moment includes the relative velocity, the serialized data format includes the following fields: the first flag bit, the second flag bit, and the relative velocity storage field. Therefore, it can be known based on the foregoing descriptions related to the first flag bit, the second flag bit, and the relative velocity storage field that, when the engine server fills the at least one field of the serialized data format according to the serialization mechanism and the obtained relative pose information, the engine server may first determine whether the absolute velocity of the virtual object at the current moment is zero. If the absolute velocity of the virtual object at the current moment is zero, the first flag bit is filled with the valid value (for example, the value 1). Otherwise, the first flag bit is filled with an invalid value (for example, a value 0). In addition, it is determined whether the relative velocity of the virtual object at the current moment is zero. If the relative velocity of the virtual object at the current moment is zero, the second flag bit is filled with the valid value (for example, the value 1). Otherwise, the second flag bit is filled with the invalid value (for example, the value 0). Then, it is detected whether the value of one of the first flag bit and the second flag bit is the valid value. If the value of one of the first flag bit and the second flag bit is the valid value, filling processing on the relative velocity storage field is forbidden. If the value of one of the first flag bit and the second flag bit is not the valid value, serialization processing is performed on the relative velocity of the virtual object at the current moment by using the serialization mechanism (namely, an FVector), and specifically, the relative velocity may be filled in a data format (namely, a data format shown in FIG. 1B) of the serialization mechanism (namely, the FVector), to obtain a serialization result. Then, the corresponding serialization result is written into the relative velocity storage field.

When the relative pose information of the virtual object at the current moment further includes the relative location, the serialized data format includes the following field: the relative location storage field. Therefore, it can be known based on the foregoing descriptions related to the relative location storage field that, when the engine server fills the at least one field of the serialized data format according to the serialization mechanism and the obtained relative pose information, the engine server may perform serialization processing on a relative location of the virtual object at the current moment by using the serialization mechanism (namely, the FVector), and may specifically fill the relative location in the data format (namely, the data format shown in FIG. 1B) of the serialization mechanism (namely, the FVector), to obtain a serialization result. Then, the corresponding serialization result is written into the relative location storage field.

It can be known from the foregoing descriptions that, the relative pose information obtained by the engine server in S405 includes the yaw angle of the virtual object at the current moment. In this case, the obtained relative pose information needs to be written into the property synchronization data stream, and the yaw angle of the virtual object at the current moment also needs to be written into the property synchronization data stream. Based on this, when filling the at least one field in the serialized data format according to the relative pose information of the virtual object at the current moment, the engine server may further fill the at least one field in the serialized data format according to the yaw angle of the virtual object at the current moment. Specifically, it can be known based on the foregoing descriptions related to the orientation storage field and the third flag bit, the engine server may first determine whether the yaw angle of the virtual object at the current moment changes compared with a yaw angle of the virtual object at the previous moment. If the yaw angle of the virtual object at the current moment changes, the orientation storage field is configured for storing the yaw angle, for example, the third flag bit is filled with the valid value (for example, the value 1). Otherwise, the orientation storage field is null, for example, the third flag bit is filled with the invalid value (for example, the value 0). When the third flag bit is filled with the invalid value, the yaw angle of the virtual object at the current moment is mapped from [0, 360) to [0, 256), to obtain a mapping value, and the orientation storage field is filled with the mapping value.

If the serialized data format includes the client synchronization sequence number field, because the pose information sequence number in the client synchronization sequence number field is configured for restricting the quantity-of-times threshold of continuously using the relative pose information to perform information synchronization to avoid an excessively large accumulated error calculated on the client side, the engine server may first update, after obtaining the serialized data format, the pose information sequence number in the client synchronization sequence number field in the serialized data format through a plus-one operation. The updating of the pose information sequence number fails if the pose information sequence number before the updating has been equal to a maximum value allowed to be filled in the client synchronization sequence number field. For example, it is assumed that the client synchronization sequence number field in the obtained serialized data format occupies five bits in total, that is, the maximum value allowed to be filled in the client synchronization sequence number field is 32 (25<32), that is, the quantity-of-times threshold of continuously using the relative pose information of the virtual object to perform information synchronization is 32. In this case, if the pose information sequence number in the client synchronization sequence number field in the obtained serialized data format is 16, because 16 is less than the maximum value, the pose information sequence number may be successfully updated to 17 through the plus-one operation. If the pose information sequence number in the client synchronization sequence number field in the obtained serialized data format is 32, because 32 is equal to the maximum value, the pose information sequence number in the client synchronization sequence number field cannot be updated through the plus-one operation.

If the updating succeeds, it indicates that a current quantity of times of continuously using the relative pose information to perform information synchronization does not exceed the quantity-of-times threshold. Therefore, the relative pose information of the virtual object at the current moment may be continuously synchronized. Therefore, the operation of filling at least one field in the serialized data format according to the serialization mechanism and the obtained relative pose information, to obtain the relative pose serialization data may be triggered to be performed. If the updating fails, it indicates that the current quantity of times of continuously using the relative pose information to perform information synchronization reaches the quantity-of-times threshold. Therefore, it may be determined in this case that the relative pose serialization data cannot be obtained, the absolute pose information of the virtual object at the current moment is written into the property synchronization data stream corresponding to the client by using the serialization mechanism, and the client synchronization sequence number field in the serialized data format is reset, so that a value of a pose information sequence number in the reset client synchronization sequence number field is zero.

The manner of writing the absolute pose information of the virtual object at the current moment into the property synchronization data stream corresponding to the client by using the serialization mechanism includes: performing serialization processing on the absolute pose information of the virtual object at the current moment by using the serialization mechanism, to obtain absolute pose serialization data, and writing the absolute pose serialization data into the property synchronization data stream corresponding to the client. Further, the absolute pose serialization data includes absolute location serialization data and absolute velocity serialization data, the absolute location serialization data is obtained by filling the absolute location into the data format shown in FIG. 1B, and the absolute velocity serialization data is obtained by filling the absolute velocity into the data format shown in FIG. 1B.

S407: Buffer the relative pose serialization data to local space.

S408: Read the relative pose serialization data from the local space in response to an information synchronization requirement of the client, and write the relative pose serialization data into the property synchronization data stream corresponding to the client, to transmit the property synchronization data stream to the corresponding client.

In a possible implementation, the engine server may directly read the relative pose serialization data from the local space in response to the information synchronization requirement of the client, and write the relative pose serialization data into the property synchronization data stream corresponding to the client.

For a same Actor, absolute locations synchronized by the engine server to different clients may be different, for example, if downlink bandwidth data is saturated when a client displays a frame of image, no property information of the Actor is synchronized in this case, that is, absolute pose information related to the virtual object is not synchronized in this case. In this case, when the client calculates relative pose information of the virtual object, absolute pose information based by the client is different from absolute pose information based by the engine server. In this case, the absolute pose information stored by the client is not latest absolute pose information, that is, the stored absolute pose information is invalid information. If relative pose information of the virtual object at a current moment is still synchronized to the client, the absolute pose information calculated by the client based on the relative pose information and the invalid absolute pose information is inaccurate.

Therefore, after detecting the information synchronization requirement of the client, the engine server may first obtain a historical information identifier from a communication channel corresponding to the client. The communication channel corresponding to the client may include description information (FSendingRepState, structure information) configured for describing an information synchronization situation. Information related to synchronizing data to a client for an Actor, such as a historical information identifier, is stored in the description information (FSendingRepState). Therefore, the historical information identifier may be obtained from FSendingRepState in the communication channel corresponding to the client. The so-called historical information identifier is an information identifier of reference absolute pose information in the client. The reference absolute pose information is absolute pose information of the virtual object received by the client last time before the current moment. Then, whether the reference absolute pose information in the client is valid absolute pose information is determined by determining whether the historical information identifier satisfies a preset identification condition. If the historical information identifier satisfies the preset identification condition, it is determined that the reference absolute pose information in the client is the valid absolute pose information, and in this case, S408 may be triggered to be performed. If the historical information identifier does not satisfy the preset identification condition, it is determined that the reference absolute pose information in the client is invalid absolute pose information, and in this case, the absolute pose information of the virtual object at the current moment may be written into the property synchronization data stream corresponding to the client by using the serialization mechanism.

In an implementation, the engine server may store, in a ring buffering manner, a particular quantity of pieces of absolute pose information generated by the virtual object at historical moments, to mark valid absolute pose information by using a valid starting pose index (HistoryMoveStart) and a valid ending pose index (HistoryMoveEnd), to determine whether the reference absolute pose information in the client is the valid absolute pose information. In this implementation, a historical pose information array of the virtual object is buffered in the local space of the engine server. The historical pose information array includes a plurality of pose indexes and a storage location indicated by each pose index, storage locations indicated by different pose indexes are configured for storing absolute pose information of the virtual object at different moments, and absolute pose information of the virtual object is stored in at least one storage location.

A pose index corresponding to a first storage location in the at least one storage location is the valid starting pose index, and a pose index corresponding to a last storage location in the at least one storage location is the valid ending pose index. For example, it is assumed that the historical pose information array includes 10 pose indexes, which are sequentially HistoryMove 1, HistoryMove 2, . . . , HistoryMove 9, and HistoryMove 10; and a storage location corresponding to each pose index may be indicated by using a rectangular box, a solid-line rectangular box is configured for indicating a storage location at which absolute pose information is stored, and a dashed-line box is configured for indicating a storage location at which absolute pose information is not stored. In this case, referring to FIG. 5B, absolute pose information is stored in the first seven storage locations in the historical pose information array. In this case, the valid starting pose index is HistoryMove 1, and the valid ending pose index is HistoryMove 7. The manner of determining the valid starting pose index and the valid ending pose index is merely exemplary, which is not limited herein. For example, a pose index corresponding to a penultimate storage location in the at least one existing storage location may alternatively be used as the valid ending pose index.

After obtaining the absolute pose information of the virtual object at the current moment and the corresponding relative pose information, the engine server determines, based on the historical pose information array, whether to synchronize the relative pose information of the virtual object at the current moment to the client; and each time absolute pose information of the virtual object is generated, the generated absolute pose information may be stored into the historical pose information array. Therefore, the historical pose information array mentioned in this embodiment of this application may include the absolute pose information of the virtual object at the current moment, and the absolute pose information is located at the last storage location in the at least one storage location (that is, the storage location at which the absolute pose information is stored) in the historical pose information array.

Therefore, it can be known that, when the valid ending pose index is the pose index of the last storage location in the at least one storage location, the valid ending pose index is a pose index of the absolute pose information of the virtual object at the current moment. In this case, if the valid ending pose index is the same as the valid starting pose index, it indicates that only the absolute pose information of the virtual object at the current moment is stored in the historical pose information array, and valid historical absolute pose information (that is, absolute pose information generated before the current moment) is not stored in the historical pose information array. Alternatively, only the absolute pose information of the virtual object obtained before the current moment may be stored in the historical pose information array, and the absolute pose information of the virtual object at the current moment is not stored in the historical pose information array. In this case, if the valid ending pose index is the same as the valid starting pose index, it indicates that only one piece of valid historical absolute pose information is stored in the historical pose information array.

Correspondingly, when the historical pose information array of the virtual object is buffered in the local space of the engine server, the historical information identifier obtained from the communication channel corresponding to the client may include a historical pose index, that is, a pose index of the absolute pose information of the virtual object received by the client last time before the current moment. In this case, the identification condition may include that the historical pose index needs to be located between the valid starting pose index and the valid ending pose index. A meaning of “the historical pose index needs to be located between the valid starting pose index and the valid ending pose index” mentioned herein may be understood as that the historical pose index is greater than the valid starting pose index and less than the valid ending pose index. In a possible implementation, when the historical pose index is equal to the valid starting pose index, it may also be considered that the historical pose index is located between the valid starting pose index and the valid ending pose index. This is not limited in the embodiments of this application.

In another implementation, considering a memory size, the engine server keeps no excessively large quantity of pieces of absolute pose information for each Actor, for example, the quantity is set to 8, 16, or 32 (which may be customized). It can be learned that, a quantity of storage locations in the historical pose information array of the virtual object is limited. The historical pose information array is configured for storing the absolute pose information of the virtual object in a ring buffering manner. The ring buffering manner is a first-in-first-out data buffering manner. Through the ring buffering manner, when no idle storage location exists in the historical pose information array, each time one piece of absolute pose information needs to be written into the historical pose information array, absolute pose information in the first storage location in the historical pose information array is popped up, and remaining pieces of absolute pose information are sequentially moved forward by one storage location, to write the to-be-written absolute pose information into the last storage location in the historical pose information array. Based on this, it can be learned that, as absolute pose information is continuously written, the absolute pose information stored at each storage location in the historical pose information array changes. Because a pose index of absolute pose information is determined according to a corresponding storage location, after a period of time, the absolute pose information pointed to by the historical pose index stored in the communication channel corresponding to the client may not be the same as absolute pose information previously synchronized by the engine server to the client.

In this case, to prevent this case, in this embodiment of this application, an information version number may be added to absolute pose information in each property information (FRepMovement) of the virtual object under the movement property. In other words, absolute pose information of the virtual object at any moment has an information version number. In addition, if a version number change event is not detected at an i^{th} moment, an information version number of absolute pose information of the virtual object at the i^{th} moment is consistent with an information version number of absolute pose information of the virtual object at an (i−1)^{th} moment, where i is an integer greater than 1. The version number change event is an event in which it is detected that absolute pose information needs to be synchronized. It can be learned that, if information version numbers of absolute pose information at two adjacent moments are the same, it may indicate that the pose information synchronized at a latter moment in the two adjacent moments is relative pose information, so that it may indicate that absolute pose information synchronized last time is valid before the latter moment.

Therefore, it can be learned that, in this embodiment of this application, whether the reference absolute pose information in the client is the valid absolute pose information may be determined by comparing an information version number at the client side with a latest information version number buffered in local space (that is, an information version number of the absolute pose information of the virtual object at the current moment). Correspondingly, the historical information identifier obtained from the communication channel corresponding to the client may include a historical information version number, that is, an information version number of the absolute pose information of the virtual object received by the client last time before the current moment. In this case, the identification condition may include that the historical information version number is the same as the information version number buffered in the local space. The information version number buffered in the local space is the latest information version number, that is, the information version number of absolute pose information of the virtual object at the current moment.

The foregoing version number change event may include any one of the following:

\textcircled{1} An event in which status information of the virtual object changes. In other words, a version number change occasion is that a status of the virtual object changes. For example, status information configured for indicating that the virtual object is attached to another virtual object changes to status information configured for indicating that the virtual object is not attached to the another virtual object. For another example, status information configured for indicating that the virtual object is in physics simulation changes to status information configured for indicating that the virtual object is not in the physics simulation. If the status information of the virtual object changes, a relationship between the virtual object and the status condition changes. If that the virtual object is not attached to another Actor changes to that the virtual object is attached to the another Actor, in this case, the relationship between the virtual object and the status condition changes from a relationship in which the virtual object has the status condition to a relationship in which the virtual object does not have the status condition, thereby changing from synchronization of the relative pose information to synchronization of the absolute pose information. In this way, the previously used absolute pose information becomes invalid. Therefore, in this case, a version number of the absolute pose information may change, so that it is subsequently accurately recognized, through version number comparison, that the previous absolute pose information is invalid absolute pose information.

\textcircled{2} An event in which the relative pose information has been synchronized for K consecutive times. In other words, a version number change occasion is that information synchronization is performed for K consecutive times (K is a positive integer) by using the relative pose information. To be specific, in this embodiment of this application, after the relative pose information is used for K consecutive times, the absolute pose information is set to be compulsorily synchronized once, so that the previously used absolute pose information becomes invalid. In this case, a version number of the absolute pose information may change, so that it is subsequently accurately recognized, through version number comparison, that the previous absolute pose information is invalid absolute pose information. Such a processing manner can prevent the client from continuously using the relative pose information for a plurality of times to determine the absolute pose information, thereby avoiding an excessively large accumulated error.

It can be known based on the foregoing version number change event that, after information synchronization is performed for a plurality of times, a pose information synchronization situation between the engine server and the client may be exemplarily shown in FIG. 5C: In a long-time property synchronization process, absolute pose information and relative pose information of the virtual object may appear at intervals, and a quantity of pieces of relative pose information that are continuously used each time is unfixed. This is caused by the foregoing information version number change occasion.

A packet loss easily occurs in the property information synchronization process. If the packet loss occurs, a UActorChannel (namely, the communication channel) corresponding to the client may set an associated changed property list that has been transmitted to a retransmission state, so that during synchronization of a changed property list in next information synchronization, the property list that needs to be retransmitted is also added. Based on this, if a packet loss occurs on the client, the historical information identifier in the communication channel corresponding to the client is reset to an invalid value, where when the historical information identifier is the invalid value, the historical information identifier does not satisfy the preset identification condition. To be specific, when packet loss processing occurs, the client may set to reset buffered historical information identifiers such as the historical information version number and the historical pose index to the invalid value. In this way, during next information synchronization, the historical information version number and the historical pose index inevitably cannot satisfy the corresponding identification conditions. Consequently, during the next information synchronization, absolute pose information is inevitably used. It can be known from the foregoing descriptions that, the serialized data format configured for performing serialization on the relative pose information includes the client synchronization sequence number field configured for storing the pose information sequence number. Therefore, it can be known that, each time relative pose information is synchronized to the client, a pose information sequence number is synchronized to the client. The pose information sequence number is configured for indicating the quantity of times of continuously using the relative pose information of the virtual object to perform information synchronization. In this case, each time the client receives a pose information sequence number, the client may calculate a difference between the currently received pose information sequence number and a previously received pose information sequence number, and determine, if the difference is greater than a threshold (for example, a value 1), that the packet loss occurs.

S408 in this embodiment of this application is an implementation of S204 in the method embodiment shown in FIG. 2. The processing logic of determining whether to synchronize the relative pose information by determining whether the reference absolute pose information in the client is valid absolute pose information is also applicable to the method embodiment shown in FIG. 2. To be specific, in the method embodiment shown in FIG. 2, before S204 is performed, the historical information identifier may be obtained from the communication channel corresponding to the client. If the historical information identifier satisfies the preset identification condition, it is determined that the reference absolute pose information in the client is the valid absolute pose information, and S204 is triggered to be performed. Otherwise, the absolute pose information of the virtual object at the current moment is written into the property synchronization data stream corresponding to the client by using the serialization mechanism.

In this embodiment of this application, a value change characteristic analysis may be performed on a serialization mechanism for absolute pose information, and it is learned that the serialization mechanism has the following value change characteristic: a data volume of data obtained by performing serialization on any pose information by using the serialization mechanism is positively correlated with a value of the corresponding pose information. In this way, after absolute pose information of a virtual object in a virtual scene at a current moment is obtained, relative pose information of the virtual object at the current moment may be obtained by considering the value change characteristic of the serialization mechanism. Because the obtained relative pose information is configured for reflecting a difference between the absolute pose information of the virtual object at the current moment and absolute pose information of the virtual object at a previous moment, a value of the relative pose information is much less than a value of the absolute pose information, and particularly, when a difference between absolute pose information at two adjacent moments is relatively small, the value of the relative pose information may be a very small value. In this case, compared with serialization of an absolute pose, the relative pose information is written into a property synchronization data stream by using the serialization mechanism, which can effectively reduce a data volume for pose synchronization, thereby effectively reducing bandwidth costs, and improving synchronization efficiency of pose information.

In an actual application, the information synchronization methods shown in FIG. 2 and FIG. 4 may be applied to various virtual scenes, such as a game scene, and a scene in a television drama. When the information synchronization method is applied to the game scene, in a running process of a game, a server end connection object (that is, a virtual object operated by a player in a virtual scene) corresponding to a client (that is, a game client) used by a game player is synchronously associated with a network of another Actor through UActorChannel type management, and changed property information of another Actor around is collected at a particular frequency (if a changed property list of the corresponding Actor is not calculated at a current moment, the changed property list is first calculated). If the collected property information is property information under a movement property and satisfies a status condition in which relative pose information can be used, the relative pose information is calculated according to the collected property information, and the relative pose information is written into a property synchronization data stream corresponding to the client (original absolute pose information is not written).

For example, as shown in FIG. 5D, an application process of using the information synchronization method in the game scene is approximately as follows:

First, a changed property list of an Actor at a current moment may be obtained. The property list includes n properties and property information of the Actor under each property, where n is a positive integer. Then, the properties in the property list may be traversed. If a currently traversed property is a movement property, absolute pose information (for example, an absolute velocity, or an absolute location) of the Actor at the current moment is obtained from property information (FRepMovement) corresponding to the movement property in the property list.

Then, it may be determined whether the absolute pose information may be replaced with relative pose information. Specifically, whether the Actor has a status condition of using the relative pose information may be determined according to status information of the Actor at the current moment. If the Actor has the status condition of using the relative pose information, it may be determined that the absolute pose information may be replaced with the relative pose information. If the Actor does not have the status condition of using the relative pose information, it may be determined that the absolute pose information cannot be replaced with the relative pose information.

If the absolute pose information may be replaced with the relative pose information, the relative pose information of the Actor at the current moment may be obtained from to-be-processed property information (FRepRelativeMovement) of the Actor, to replace serialization data of the absolute pose information with serialization data of the relative pose information during subsequent writing. In a possible implementation, serialization processing may be performed on the obtained relative pose information by using a serialization mechanism such as an FVector, to obtain relative pose serialization data (that is, the serialization data of the relative pose information), and the relative pose serialization data is buffered in local space, so that the relative pose serialization data is subsequently written into a property synchronization data stream of one or more clients.

For any client, such as a client 1 or a client 2 shown in FIG. 5D, when an information synchronization requirement of the any client is detected, it may be determined, according to information such as a network status of any client side, whether the relative pose serialization data may be written into a communication channel (Actor Channel) corresponding to the any client. For example, if the network status indicates that a downstream bandwidth of any client is saturated or a network connection to the any client is disconnected, it is determined that the relative pose serialization data cannot be written. If the network status indicates that the downstream bandwidth of the any client is not saturated or the network connection to the any client is not disconnected, it is determined that the relative pose serialization data may be written. If it is determined that the relative pose serialization data may be written, the relative pose serialization data may be written into a property synchronization data stream corresponding to the any client by using a ReplicateActor (a function name for property replication) method, and the property synchronization data stream is written into a communication channel corresponding to the any client, to transmit the property synchronization data stream to the corresponding client through the corresponding network connection.

The communication channel of the any client may include FSendingRepState (description information), and a historical pose index and a historical information version number that are used during synchronization of absolute pose information last time are stored in each FSendingRepState. In this case, referring to FIG. 5E, when the information synchronization requirement of the any client is detected, the historical pose index and the historical information version number may be first obtained from the communication channel of the any client. Whether the historical pose index is a valid pose index is determined by determining whether the historical pose index (for example, HistoryMove 3 shown in FIG. 5E) is located between a valid starting pose index (for example, HistoryMove 2 shown in FIG. 5E) and a valid ending pose index (for example, HistoryMove n−1 shown in FIG. 5E) of the historical pose information array. In addition, whether the historical information version number is the same as an information version number stored in the local space of an engine server.

If both of the two are satisfied (that is, the information version numbers are the same and the historical pose index is the valid pose index), it may be detected whether the relative pose serialization data is buffered in the local space. If the relative pose serialization data is buffered in the local space, the operation of writing the relative pose serialization data into a property synchronization data stream by using a ReplicateActor (a function name for property replication) method is triggered to be performed. If the relative pose serialization data is not buffered in the local space, the relative pose serialization data is calculated, and the relative pose serialization data is written into the property synchronization data stream. Specifically, according to absolute pose information in property information (FHistoryRepMovement) under a movement property of a virtual object at a previous moment (for example, absolute pose information in a storage location indicated by HistoryMove 3 in FIG. 5E), and according to absolute pose information of the virtual object at the current moment (that is, absolute pose information in property information under a movement property obtained at the current moment shown in FIG. 5E), relative pose information of the virtual object at the current moment may be calculated, and serialization processing may be performed on the relative pose information, to obtain relative pose serialization data.

If at least one of the historical pose index and the historical information version number does not satisfy a corresponding condition, the absolute pose information of the virtual object at the current moment may be written into the property synchronization data stream. In addition, a pose information sequence number in the communication channel may be reset to zero, the historical pose index is reset to a pose index of the absolute pose information of the virtual object at the current moment, and the historical information version number is reset to an information version number of the absolute pose information of the virtual object at the current moment.

In this embodiment of this application, synchronization of absolute pose information in default implementation of an engine server (UE DS) may be changed to a combination of the absolute pose information and relative pose information. Because the obtained relative pose information is configured for reflecting a difference between absolute pose information of a virtual object at a current moment and absolute pose information of the virtual object at a previous moment, a value of the relative pose information is much less than a value of the absolute pose information, and particularly, when a difference between absolute pose information at two adjacent moments is relatively small, the value of the relative pose information may be a very small value. In this case, compared with serialization of an absolute pose, the relative pose information is written into a property synchronization data stream by using a serialization mechanism, which can effectively reduce a data volume for pose synchronization, thereby effectively reducing bandwidth costs, and improving synchronization efficiency of pose information. In this way, rendering efficiency of a game picture on a client side is improved, thereby improving smoothness of game running.

To further describe feasibility of the information synchronization method provided in this embodiment of this application in the game scene, in an embodiment of this application, a performance test is performed on the information synchronization method in the game scene, to obtain the following test results:

(A) Bandwidth costs required for pose synchronization can be greatly reduced.

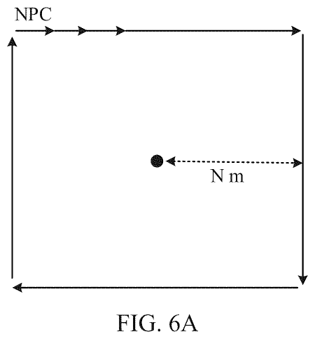

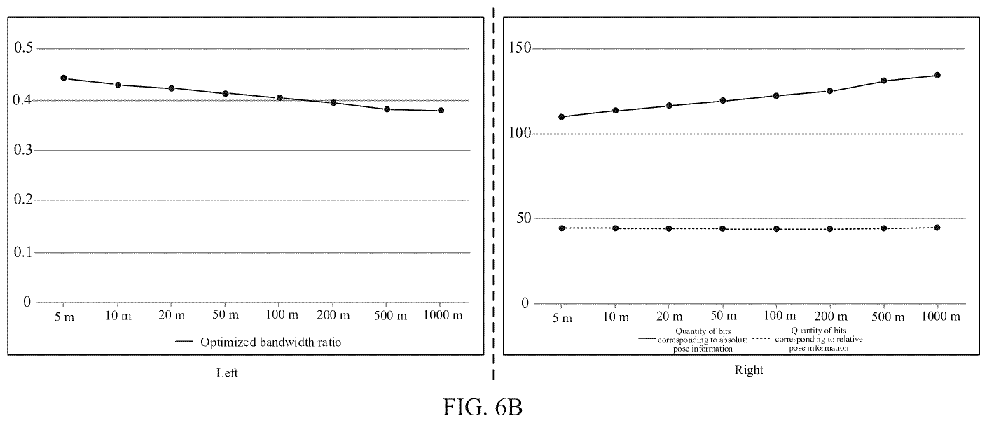

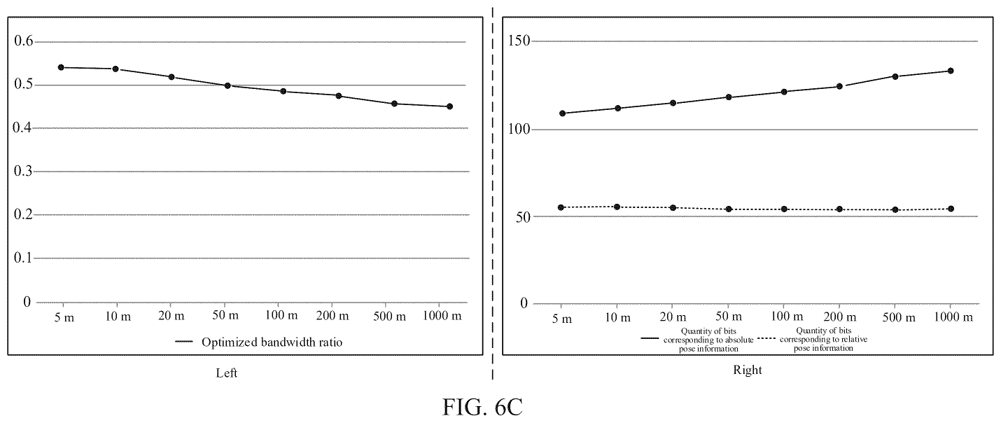

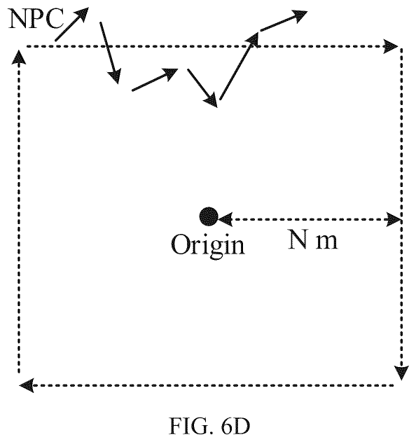

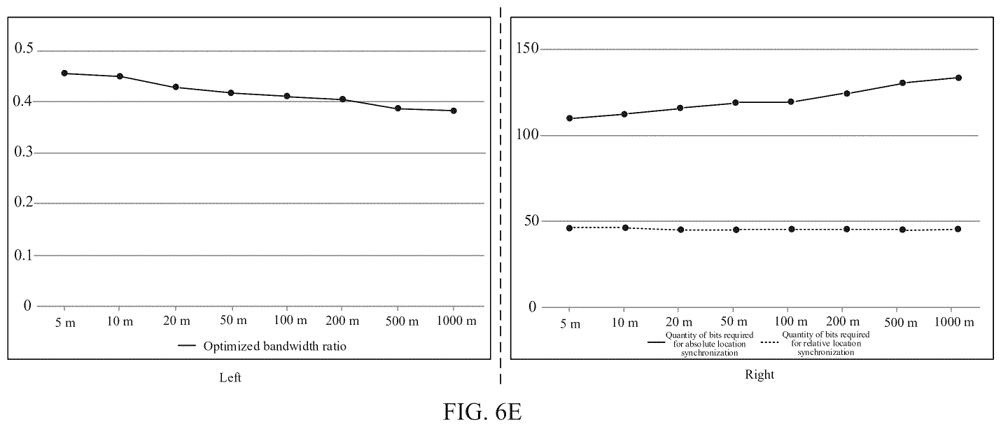

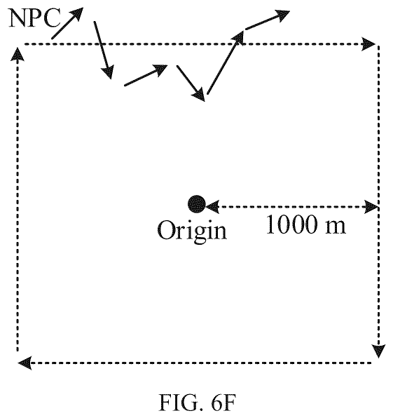

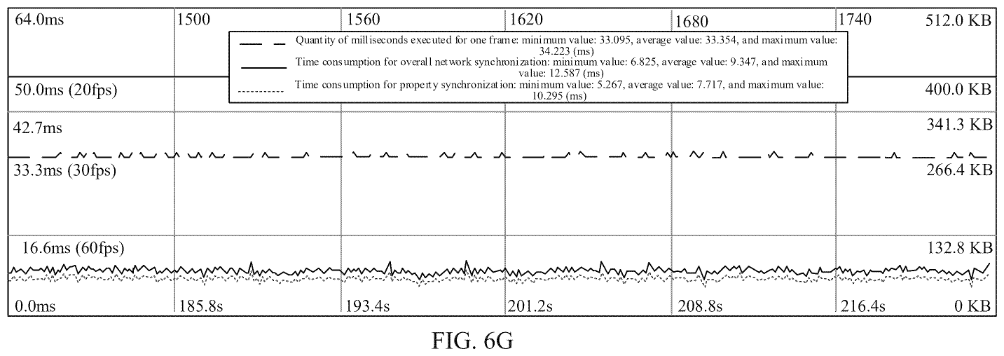

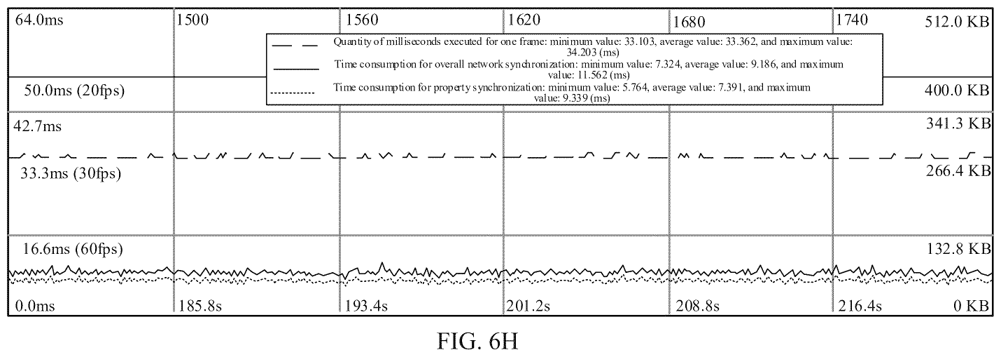

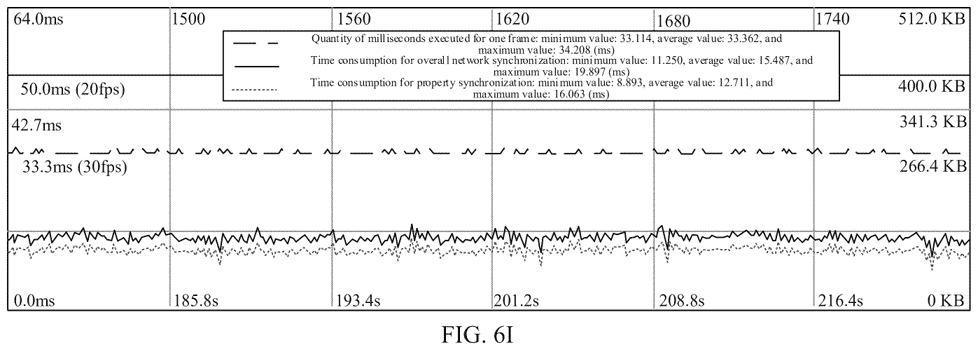

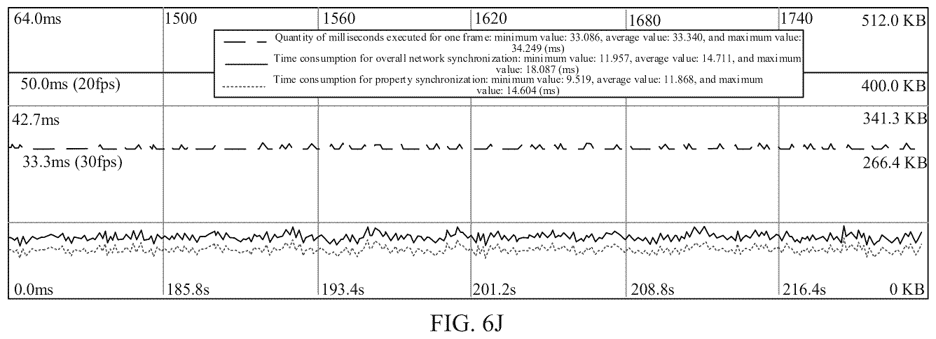

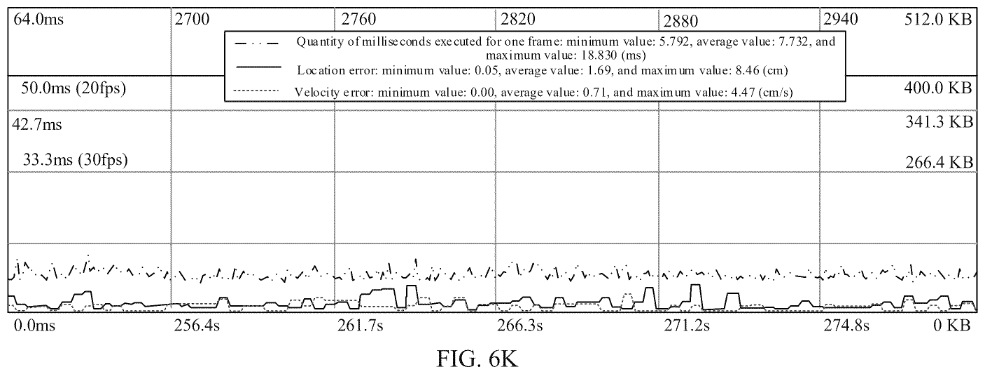

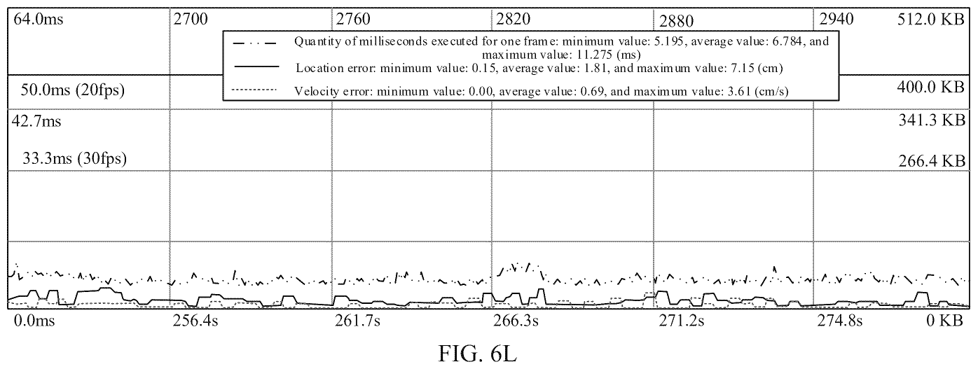

(1) Test case 1: A network synchronization frame rate of a server end is 30 Hz. A non-player character (NPC) (that is, a game character that is in a game and that is not controlled by a real player) moves at a particular velocity along a rectangle with a particular distance (that is, N m) from an origin, pauses once every particular distance (for example, waits for 0.3 s when an orientation changes), and then moves directionally along the rectangle. In other words, changes of the orientation and the velocity are increased through pausing once, thereby increasing a synchronized data volume, as shown in FIG. 6A.

\textcircled{1} A maximum velocity of the NPC during the directional movement is set to 6 m/s, and the NPC pauses once every 5 m. A plurality of cases in which N is 5 m, 10 m, 20 m, 50 m, 100 m, 200 m, 500 m, and 1000 m are respectively tested, and a result graph shown in FIG. 6B is obtained. It can be known based on a right diagram in FIG. 6B that, as a distance of the NPC from the origin becomes larger, an absolute location of the NPC becomes larger, and a quantity of bits required for synchronizing absolute pose information (including an absolute location) once becomes larger, while a quantity of bits required for synchronizing relative pose information (including a relative location) is relatively stable and is less than the former by more than half. A left diagram in FIG. 6B shows that, an optimized pose bandwidth ratio (that is, a ratio of a bandwidth required for synchronizing the relative pose information to a bandwidth required for synchronizing the absolute pose information) is less than 1. Therefore, it can be known that, a ratio of the bandwidth ratio of the bandwidth required for synchronizing the relative pose information to a bandwidth in a default implementation (that is, the bandwidth required for synchronizing the absolute pose information) is low. Particularly, when the distance to the origin is greater than 100 m, the bandwidth required for synchronizing the relative pose information accounts for only 40% or even less of the bandwidth in the default implementation.

\textcircled{2} A maximum velocity of the NPC during the directional movement is set to 6 m/s, and the NPC pauses once every 2.5 m. A plurality of cases in which N is 5 m, 10 m, 20 m, 50 m, 100 m, 200 m, 500 m, and 1000 m are respectively tested, and a result graph shown in FIG. 6C is obtained. It can be known by comparing FIG. 6B with FIG. 6C that, compared with pausing once every 5 m, pausing once every 2.5 m increases a frequency of changing the orientation and the velocity, increasing a bandwidth required for synchronizing the pose information. In this way, an optimization effect shown in FIG. 6C is slightly lower than an optimization effect shown in FIG. 6B. However, when the distance of the NPC from the origin exceeds 50 m, a bandwidth required for synchronizing the relative pose information still accounts for only 50% or even less of a bandwidth in a default implementation.

(2) Test case 2: A network synchronization frame rate of a server end is 30 Hz. An NPC randomly moves (for example, randomly changes an orientation or randomly changes a velocity) around a rectangle with a particular distance (that is, N m) from an origin, as shown in FIG. 6D.

A maximum velocity of the NPC during the random movement is set to 6 m/s. A plurality of cases in which Nis 5 m, 10 m, 20 m, 50 m, 100 m, 200 m, 500 m, and 1000 m are respectively tested, and a result graph shown in FIG. 6E is obtained. It can be known based on a right diagram in FIG. 6E that, as a distance of the NPC from the origin becomes larger, a quantity of bits required for synchronizing absolute pose information once becomes larger, while a quantity of bits required for synchronizing relative pose information is relatively stable and is less than the former by more than half. It can be known based on a left diagram in FIG. 6E that, a bandwidth required for synchronizing the relative pose information accounts for only 50% or less of a bandwidth in a default implementation, that is, a ratio of the bandwidth required for synchronizing the relative pose information to the bandwidth in the default implementation is low.

(B) No additional central processing unit (CPU) overhead is added.

Test case: A network synchronization frame rate of a server end is 30 Hz. An NPC randomly moves around a rectangle with 1000 m from an origin, as shown in FIG. 6F. Statistics about information such as time consumption for overall network synchronization (NetDriver TickFlush) and time consumption for property synchronization (Replicate Actor Time) of each frame are collected.

\textcircled{1} 100 NPCs are set to randomly move, and 20 game players log in to a game.

When information synchronization is performed by using absolute pose information, a corresponding statistical result may be shown in FIG. 6G. It can be known based on FIG. 6G that, during synchronization of the absolute pose information, average time consumption for overall network synchronization is 9.347 ms, and average time consumption for property synchronization is 7.717 ms. In addition, statistics about a data volume (Out Rate) for the overall network synchronization in this case are collected, and it is found that a minimum value thereof is approximately 777 KB/s, an average value thereof is approximately 836 KB/s, and a maximum value thereof is approximately 873 KB/s. In addition, statistics about a data volume (RepMovement Origin Bits) required for synchronizing the absolute pose information are collected, and it is found that a minimum value thereof is approximately 2911399 Kbits, an average value thereof is approximately 3046768 Kbits, and a maximum value thereof is approximately 3181405 Kbits.

When information synchronization is performed by using relative pose information, a corresponding statistical result may be shown in FIG. 6H. It can be known based on FIG. 6H that, during synchronization of the relative pose information, average time consumption for overall network synchronization is 9.186 ms, and average time consumption for property synchronization is 7.391 ms. In addition, statistics about a data volume for the overall network synchronization in this case are collected, and it is found that a minimum value thereof is approximately 432 KB/s, an average value thereof is approximately 452 KB/s (approximately 54% of that in a default implementation), and a maximum value thereof is approximately 471 KB/s. In addition, statistics about a data volume (RepMovement Optimized Bits) required for synchronizing the relative pose information are collected, and it is found that a minimum value thereof is approximately 1158585 Kbits, an average value thereof is approximately 1212244 Kbits, and a maximum value thereof is approximately 1265747 Kbits. It can be seen that, an average data volume required for synchronizing the relative pose information is approximately 39.7% of an average data volume required for synchronizing the absolute pose information in the default implementation.

\textcircled{2} 100 NPCs are set to randomly move, and 32 game players log in to a game.

When information synchronization is performed by using absolute pose information, a corresponding statistical result may be shown in FIG. 6I. It can be known based on FIG. 6I that, during synchronization of the absolute pose information, average time consumption for overall network synchronization is 15.487 ms, and average time consumption for property synchronization is 12.711 ms. In addition, statistics about a data volume for the overall network synchronization in this case are collected, and it is found that a minimum value thereof is approximately 1280 KB/s, an average value thereof is approximately 1342 KB/s, and a maximum value thereof is approximately 1398 KB/s. In addition, statistics about a data volume required for synchronizing the absolute pose information are collected, and it is found that a minimum value thereof is approximately 676293 Kbits, an average value thereof is approximately 891129 Kbits, and a maximum value thereof is approximately 1105786 Kbits.

When information synchronization is performed by using relative pose information, a corresponding statistical result may be shown in FIG. 6J. It can be known based on FIG. 6J that, during synchronization of the relative pose information, average time consumption for overall network synchronization is 14.711 ms, and average time consumption for property synchronization is 11.868 ms. In addition, statistics about a data volume for the overall network synchronization in this case are collected, and it is found that a minimum value thereof is approximately 684 KB/s, an average value thereof is approximately 718 KB/s (approximately 54% of that in a default implementation), and a maximum value thereof is approximately 755 KB/s. In addition, statistics about a data volume required for synchronizing the relative pose information are collected, and it is found that a minimum value thereof is approximately 269092 Kbits, an average value thereof is approximately 354722 Kbits, and a maximum value thereof is approximately 440082 Kbits. It can be seen that, an average data volume required for synchronizing the relative pose information is approximately 39.8% of an average data volume required for synchronizing the absolute pose information in the default implementation.

It can be known based on the related descriptions of FIG. 6G to FIG. 6J that, time consumption required by using the relative pose information is close to time consumption required by using the absolute pose information, and the time consumption required by using the relative pose information is slightly lower. Therefore, it can be known that, during synchronization of the relative pose information, although calculation for the relative pose information is increased, a data volume required for synchronization is reduced and is slightly lower as a whole. Therefore, during the synchronization of the relative pose information, no additional CPU overhead is caused.

(C) An error caused by information synchronization based on relative pose information is relatively small, and belongs to a centimeter-level error of a single digit.

Test case: A network synchronization frame rate of a server end is 30 Hz. An NPC randomly moves around a rectangle with 1000 m from an origin, as shown in FIG. 6F.

\textcircled{1} 100 NPCs are set to randomly move, and 20 game players log in to a game.

Statistics about information such as a location error and a velocity error brought by synchronizing the relative pose information when a check mode is enabled are collected, and a statistical result shown in FIG. 6K is obtained. It can be known based on FIG. 6K that, an average location error (Relative Location Diff) is 1.69 cm, and a maximum location error is 8.46 cm; and an average velocity error (Relative Velocity Diff) is 0.71 cm/s, and a maximum velocity error is 4.47 cm/s. In addition, statistics about a quantity of times of packet losses (Relative Count Unordered) are collected, and it is found that a minimum value, a maximum value, and an average value of the quantity of times of packet losses are all 0.

\textcircled{2} 100 NPCs are set to randomly move, and 32 game players log in to a game.

Statistics about information such as a location error and a velocity error brought by synchronizing the relative pose information when a check mode is enabled are collected, and a statistical result shown in FIG. 6L is obtained. It can be known based on FIG. 6L that, an average location error (Relative Location Diff) is 1.81 cm, and a maximum location error is 7.15 cm; and an average velocity error (Relative Velocity Diff) is 0.60 cm/s, and a maximum velocity error is 3.61 cm/s.

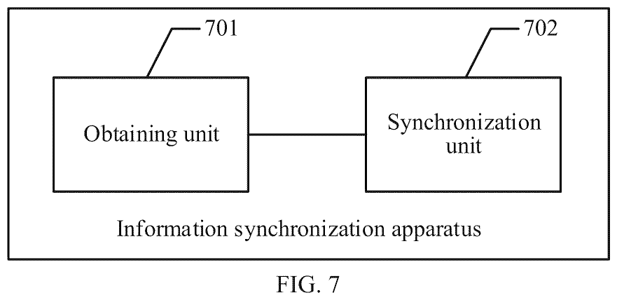

Based on the descriptions of the embodiments of the foregoing information synchronization method, an embodiment of this application further discloses an information synchronization apparatus. The information synchronization apparatus may be a computer program (including program code) running in an engine server, and the information synchronization apparatus may be configured to perform part of or all operations in the method procedure shown in FIG. 2 or FIG. 4. Referring to FIG. 7, the information synchronization apparatus may run the following units:
an obtaining unit 701, configured to obtain absolute pose information of a virtual object in a virtual scene at a current moment, the absolute pose information at the current moment being pose information determined based on a reference object at the current moment, and the pose information being synchronized to a client in a serialization manner,
the obtaining unit 701 being further configured to determine a serialization mechanism for the absolute pose information; and
the obtaining unit 701 being further configured to: if it is determined that the serialization mechanism has the following value change characteristic: a data volume of data obtained by performing serialization on any pose information by using the serialization mechanism is positively correlated with a value of the corresponding pose information, obtain relative pose information of the virtual object at the current moment based on the value change characteristic of the serialization mechanism, the obtained relative pose information being configured for reflecting a difference between the absolute pose information of the virtual object at the current moment and absolute pose information of the virtual object at a previous moment, and the absolute pose information at the previous moment being pose information determined based on the reference object at the previous moment; and
a synchronization unit 702, configured to write the obtained relative pose information into a property synchronization data stream corresponding to the client by using the serialization mechanism, to transmit the property synchronization data stream to the corresponding client.

In an implementation, the obtaining unit 701 is configured to:
obtain status information of the virtual object at the current moment, and determine a status condition that the virtual object is required to have when the relative pose information of the virtual object at the current moment is used; and
if it is determined, according to the status information, that the virtual object has the status condition, trigger to perform the operation of obtaining relative pose information of the virtual object at the current moment based on the value change characteristic of the serialization mechanism; or
if it is determined, according to the status information, that the virtual object does not have the status condition, write the absolute pose information of the virtual object at the current moment into the property synchronization data stream corresponding to the client by using the serialization mechanism.

In an implementation, the relative pose information of the virtual object at the current moment includes at least one of the following: a relative velocity and a relative location;
the status information includes at least one of the following: a status identifier configured for indicating whether the virtual object is attached to another virtual object, and a status identifier configured for indicating whether the virtual object is in physics simulation; and
the status condition includes at least one of the following: the virtual object is not attached to another virtual object, and the virtual object is not in the physics simulation.

In an implementation, the obtained relative pose information is located in to-be-processed property information of the virtual object, and the to-be-processed property information further includes a yaw angle of the virtual object at the current moment, and does not include a pitch angle and a roll angle of the virtual object at the current moment; the synchronization unit 702 is further configured to:
write, into the property synchronization data stream, the to-be-processed property information in which the obtained relative pose information is located;
the status information further includes orientation information of the virtual object, and the orientation information includes the yaw angle, the pitch angle, and the roll angle of the virtual object at the current moment; and the status condition includes that the pitch angle and the roll angle of the virtual object at the current moment are zero.

In another implementation, before the obtaining unit 701 is configured to obtain the status information of the virtual object at the current moment, the obtaining unit 701 may be further configured to:
obtain a function status of a global optimization function, the function status including an enabled state or a disabled state; and
if the function status of the global optimization function is the enabled state, trigger to perform the operation of obtaining status information of the virtual object at the current moment; or
if the function status of the global optimization function is the disabled state, obtain an object type of the virtual object, and trigger, when the object type of the virtual object is a specified object type, to perform the operation of obtaining relative pose information of the virtual object at the current moment based on the value change characteristic of the serialization mechanism.

In another implementation, when the obtaining unit 701 is configured to obtain the absolute pose information of the virtual object in the virtual scene at the current moment, the obtaining unit 701 may be further configured to:
obtain a property list of the virtual object in the virtual scene at the current moment, the property list including a plurality of properties of the virtual object and property information of the virtual object under each property; and
search for a movement property in the plurality of properties included in the property list, and obtain the absolute pose information of the virtual object at the current moment from property information corresponding to the movement property in the property list.

In another implementation, when the obtaining unit 701 is configured to search for the movement property in the plurality of properties included in the property list, the obtaining unit 701 may be further configured to:
determine a reference property type, a property under the reference property type being the movement property;
sequentially traverse the properties in the property list, and obtaining a property type of a currently traversed property; and
if the obtained property type is the same as the reference property type, determine that the currently traversed property is the movement property; or
if the obtained property type is different from the reference property type, continuously perform traversing, until the properties in the property list are traversed.

In another implementation, any pose information belongs to information of a shared serialization type. Correspondingly, after the obtaining unit 701 obtains the relative pose information of the virtual object at the current moment, the synchronization unit 702 may be further configured to perform serialization processing on the obtained relative pose information by using the serialization mechanism, to obtain relative pose serialization data, and buffering the relative pose serialization data in local space.

Correspondingly, when the synchronization unit 702 is configured to write the obtained relative pose information into the property synchronization data stream corresponding to the client by using the serialization mechanism, the synchronization unit 702 may be further configured to read the relative pose serialization data from the local space in response to an information synchronization requirement of the client, and write the relative pose serialization data into the property synchronization data stream corresponding to the client.

In another implementation, the relative pose information of the virtual object at the current moment includes a relative velocity; and when the synchronization unit 702 is configured to perform serialization processing on the obtained relative pose information by using the serialization mechanism, to obtain the relative pose serialization data, the synchronization unit 702 may be further configured to:
obtain a serialized data format, the serialized data format including the following fields: a first flag bit, a second flag bit, and a relative velocity storage field; and a value of the first flag bit being determined according to whether an absolute velocity is zero, a value of the second flag bit being determined according to whether the relative velocity is zero, and the relative velocity storage field being configured for storing a serialization result of the relative velocity; and
fill at least one field in the serialized data format according to the serialization mechanism and the obtained relative pose information, to obtain the relative pose serialization data,
when the value of the first flag bit indicates that an absolute velocity of the virtual object at the current moment is zero, or when the value of the second flag bit indicates that a relative velocity of the virtual object at the current moment is zero, the relative velocity storage field being null.

In another implementation, the relative pose information of the virtual object at the current moment further includes a relative location; and
the serialized data format further includes a relative location storage field, and the relative location storage field is configured for storing a serialization result of the relative location.

In another implementation, the relative pose information of the virtual object at the current moment includes a yaw angle of the virtual object at the current moment; and
the serialized data format further includes a third flag bit and an orientation storage field, where a value of the third flag bit is determined according to whether the yaw angle of the virtual object changes, and the orientation storage field is configured for storing the yaw angle; and when the value of the third flag bit indicates that the yaw angle of the virtual object at the current moment does not change, the orientation storage field is null.

In another implementation, the serialized data format further includes a client synchronization sequence number field, the client synchronization sequence number field is configured for storing a pose information sequence number, and the pose information sequence number is configured for indicating a quantity of times of continuously using the relative pose information of the virtual object to perform information synchronization; and correspondingly, after obtaining the serialized data format, the synchronization unit 702 may be further configured to:
update the pose information sequence number in the client synchronization sequence number field through a plus-one operation, the updating of the pose information sequence number failing if the pose information sequence number before the updating has been equal to a maximum value allowed to be filled in the client synchronization sequence number field; and
if the updating succeeds, trigger to perform the operation of filling at least one field in the serialized data format according to the serialization mechanism and the obtained relative pose information, to obtain the relative pose serialization data; or
if the updating fails, write the absolute pose information of the virtual object at the current moment into the property synchronization data stream corresponding to the client by using the serialization mechanism; and reset the client synchronization sequence number field, a pose information sequence number in the reset client synchronization sequence number field being zero.

In another implementation, the serialized data format further includes an absolute pose storage field, and the absolute pose storage field is configured for storing a serialization result of the absolute pose information;
the virtual scene is presented through an application program, the application program is configured with a synchronization optimization function, and the synchronization optimization function is a function of performing information synchronization by using the relative pose information;
if the synchronization optimization function is in a test phase and a check mode is enabled, during the filling of the serialized data format, the absolute pose storage field is required to be filled with the serialization result of the absolute pose information of the virtual object at the current moment, where the check mode is a mode of checking, by using the absolute pose information, whether the relative pose information is accurate; and
if the synchronization optimization function is in the test phase and the check mode is not enabled, or if the synchronization optimization function is in an application phase, the absolute pose storage field is null during the filling of the serialized data format.

In another implementation, the synchronization unit 702 may be further configured to:
obtain a historical information identifier from a communication channel corresponding to the client, the historical information identifier being an information identifier of reference absolute pose information in the client; and the reference absolute pose information being absolute pose information of the virtual object received by the client last time before the current moment; and
if the historical information identifier satisfies a preset identification condition, determine that the reference absolute pose information in the client is valid absolute pose information, and trigger to perform the operation of writing the obtained relative pose information into a property synchronization data stream corresponding to the client by using the serialization mechanism; or
if the historical information identifier does not satisfy the preset identification condition, determine that the reference absolute pose information in the client is invalid absolute pose information, and write the absolute pose information of the virtual object at the current moment into the property synchronization data stream corresponding to the client by using the serialization mechanism.

In another implementation, a historical pose information array of the virtual object is buffered in local space;
the historical pose information array includes a plurality of pose indexes and a storage location indicated by each pose index, storage locations indicated by different pose indexes are configured for storing absolute pose information of the virtual object at different moments, and absolute pose information of the virtual object is stored in at least one storage location; and
a pose index corresponding to a first storage location in the at least one storage location is a valid starting pose index, and a pose index corresponding to a last storage location in the at least one storage location is a valid ending pose index, where
the historical information identifier includes a historical pose index; and the identification condition includes that the historical pose index is located between the valid starting pose index and the valid ending pose index.

In another implementation, absolute pose information of the virtual object at any moment has an information version number; and
if a version number change event is not detected at an i^{th} moment, an information version number of absolute pose information of the virtual object at the i^{th} moment is consistent with an information version number of absolute pose information of the virtual object at an (i−1)^{th} moment, where i is an integer greater than 1; the version number change event includes any one of the following: an event in which status information of the virtual object changes, or an event in which the relative pose information has been synchronized for K consecutive times; and K is a positive integer, where
the historical information identifier includes a historical information version number, and an information version number of the absolute pose information of the virtual object at the current moment is buffered in the local space; and the identification condition includes that the historical information version number is the same as the information version number buffered in the local space.

In another implementation, if a packet loss occurs on the client, the historical information identifier in the communication channel corresponding to the client is reset to an invalid value, where when the historical information identifier is the invalid value, the historical information identifier does not satisfy the preset identification condition; the synchronization unit 702 may be further configured to:
synchronize a pose information sequence number of the relative pose information to the client, the pose information sequence number being configured for indicating a quantity of times of continuously using the relative pose information of the virtual object to perform information synchronization; and
the client is configured to calculate a difference between the currently received pose information sequence number and a previously received pose information sequence number, and determine, if the difference is greater than a threshold, that the packet loss occurs.

According to another embodiment of this application, the units of the information synchronization apparatus shown in FIG. 7 may be separately or wholly combined into one or several other units, or one (or more) of the units may further be divided into a plurality of units of smaller functions. In this way, same operations may be implemented, and the implementation of the technical effects of the embodiments of this application is not affected. The foregoing units are divided based on logical functions. In an actual application, a function of one unit may also be implemented by a plurality of units, or functions of a plurality of units are implemented by one unit. In another embodiment of this application, the information synchronization apparatus may also include other units. In an actual application, the functions may also be cooperatively implemented by other units and may be cooperatively implemented by a plurality of units.

According to another embodiment of this application, a computer program (including program code) that can perform the operations in the corresponding method shown in FIG. 2 or FIG. 4 may be run on a general computing device, such as a computer, which includes processing elements and storage elements such as a central processing unit (CPU), a random access memory (RAM), and a read-only memory (ROM), to construct the information synchronization apparatus shown in FIG. 7 and implement the information synchronization method in the embodiments of this application. The computer program may be recorded in, for example, a computer readable recording medium, and may be loaded into the foregoing computing device by using the computer readable recording medium, and run on the computing device.

In this embodiment of this application, a value change characteristic analysis may be performed on a serialization mechanism for absolute pose information, and it is learned that the serialization mechanism has the following value change characteristic: a data volume of data obtained by performing serialization on any pose information by using the serialization mechanism is positively correlated with a value of the corresponding pose information. In this way, after absolute pose information of a virtual object in a virtual scene at a current moment is obtained, relative pose information of the virtual object at the current moment may be obtained by considering the value change characteristic of the serialization mechanism. Because the obtained relative pose information is configured for reflecting a difference between the absolute pose information of the virtual object at the current moment and absolute pose information of the virtual object at a previous moment, a value of the relative pose information is much less than a value of the absolute pose information, and particularly, when a difference between absolute pose information at two adjacent moments is relatively small, the value of the relative pose information may be a very small value. In this case, compared with serialization of an absolute pose, the relative pose information is written into a property synchronization data stream by using the serialization mechanism, which can effectively reduce a data volume for pose synchronization, thereby effectively reducing bandwidth costs, and improving synchronization efficiency of pose information.

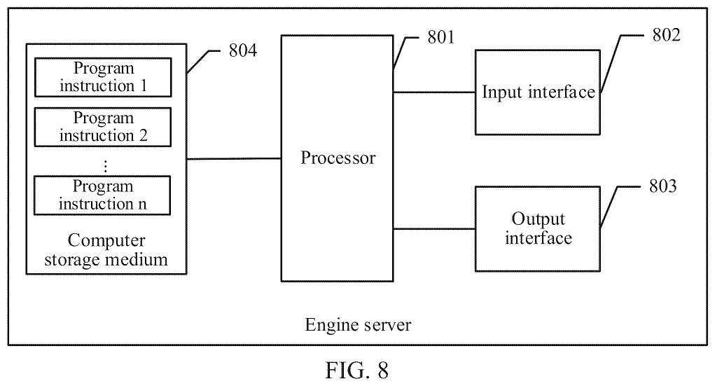

Based on the descriptions of the foregoing method embodiments and apparatus embodiments, an embodiment of this application further provides an engine server. Referring to FIG. 8, the engine server includes at least a processor 801, an input interface 802, an output interface 803, and a computer storage medium 804. The processor 801, the input interface 802, the output interface 803, and the computer storage medium 804 in the engine server may be connected by using a bus or in another manner. The computer storage medium 804 may be stored in a memory of the engine server. The computer storage medium 804 is configured to store a computer program. The computer program includes program instructions. The processor 801 is configured to execute the program instructions stored in the computer storage medium 804. The processor 801 (or referred to as a central processing unit (CPU)) is a computing core and a control core of the engine server, is adapted to implement one or more computer programs, and is specifically adapted to load and execute the one or more computer programs to implement a corresponding method procedure or a corresponding function.

In an embodiment, the processor 801 in this embodiment of this application may be configured to perform a series of information synchronization processing, specifically including: obtaining absolute pose information of a virtual object in a virtual scene at a current moment, the absolute pose information at the current moment being pose information determined based on a reference object at the current moment, and the pose information being synchronized to a client in a serialization manner; determining a serialization mechanism for the absolute pose information, the serialization mechanism having the following value change characteristic: a data volume of data obtained by performing serialization on any pose information by using the serialization mechanism is positively correlated with a value of the corresponding pose information, obtaining relative pose information of the virtual object at the current moment based on the value change characteristic of the serialization mechanism, the obtained relative pose information being configured for reflecting a difference between the absolute pose information of the virtual object at the current moment and absolute pose information of the virtual object at a previous moment, and the absolute pose information at the previous moment being pose information determined based on the reference object at the previous moment; writing the obtained relative pose information into a property synchronization data stream corresponding to the client by using the serialization mechanism, to transmit the property synchronization data stream to the corresponding client, and the like.

An embodiment of this application further provides a computer storage medium (Memory), and the computer storage medium is a memory device in an engine server and is configured to store programs and data. The computer storage medium herein may include an internal storage medium of the engine server and certainly may also include an extended storage medium supported by the engine server. The computer storage medium provides storage space, and the storage space stores an operating system of the engine server. In addition, the storage space further stores one or more instructions adapted to be loaded and executed by a processor. The instructions may be one or more computer programs (including program code). The computer storage medium herein may be a high-speed RAM memory, or may be a non-volatile memory such as at least one magnetic disk storage. In one embodiment, the computer storage medium may be at least one computer storage medium far away from the foregoing processor.

In another embodiment, the processor may load and execute one or more computer programs stored in the computer storage medium, to implement corresponding operations of the embodiments of the method in FIG. 2 or FIG. 4. In a specific implementation, the one or more computer programs in the computer storage medium are loaded by the processor to perform the information synchronization method provided in the foregoing embodiments.

According to an aspect of this application, a computer program product or a computer program is further provided, the computer program product or the computer program including computer instructions, the computer instructions being stored in a computer-readable storage medium. A processor of a computer device reads the computer instructions from the computer-readable storage medium, and the processor executes the computer instructions, to cause the computer device to perform the method provided in the various exemplary implementations of the embodiment aspects of the data processing method shown in FIG. 2 or FIG. 4. What are disclosed above are merely examples of the embodiments of this application, and certainly are not intended to limit the protection scope of this application. Therefore, equivalent variations made in accordance with the claims of this application shall fall within the scope of this application.

In this application, the term “unit” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each unit can be implemented using one or more processors (or processors and memory). Likewise, a processor (or processors and memory) can be used to implement one or more units. Moreover, each unit can be part of an overall unit that includes the functionalities of the unit.

What is claimed is:

1. An information synchronization method performed by a computer device, the method comprising:
obtaining absolute pose information of a virtual object in a virtual scene at a current moment, the absolute pose information at the current moment being pose information determined based on a reference object at the current moment;
determining a serialization mechanism for the absolute pose information;
when the serialization mechanism has the following value change characteristic: a data volume of data obtained by performing serialization on pose information by using the serialization mechanism is positively correlated with a value of the corresponding pose information, obtaining relative pose information of the virtual object at the current moment based on the value change characteristic of the serialization mechanism; and
writing the obtained relative pose information into a property synchronization data stream corresponding to a client by using the serialization mechanism, to transmit the property synchronization data stream to the client.

2. The method according to claim 1, further comprising:
obtaining status information of the virtual object at the current moment, and determining a status condition that the virtual object is required to have when the relative pose information of the virtual object at the current moment is used;
when the virtual object has the status condition, performing the operation of obtaining relative pose information of the virtual object at the current moment based on the value change characteristic of the serialization mechanism; and
when the virtual object does not have the status condition, writing the absolute pose information of the virtual object at the current moment into the property synchronization data stream corresponding to the client by using the serialization mechanism.

3. The method according to claim 2, wherein the relative pose information of the virtual object at the current moment comprises at least one of the following: a relative velocity and a relative location;
the status information comprises at least one of the following: a status identifier configured for indicating whether the virtual object is attached to another virtual object, and a status identifier configured for indicating whether the virtual object is in physics simulation; and
the status condition comprises at least one of the following: the virtual object is not attached to another virtual object, and the virtual object is not in the physics simulation.

4. The method according to claim 2, wherein before the obtaining status information of the virtual object at the current moment, the method further comprises:
obtaining a function status of a global optimization function, the function status comprising an enabled state or a disabled state; and
when the function status of the global optimization function is the enabled state, performing the operation of obtaining status information of the virtual object at the current moment; or
when the function status of the global optimization function is the disabled state, obtaining an object type of the virtual object, and when the object type of the virtual object is a specified object type, performing the operation of obtaining relative pose information of the virtual object at the current moment based on the value change characteristic of the serialization mechanism.

5. The method according to claim 1, wherein the obtaining absolute pose information of a virtual object in a virtual scene at a current moment comprises:
obtaining a property list of the virtual object in the virtual scene at the current moment, the property list comprising a plurality of properties of the virtual object and property information of the virtual object under each property; and
searching for a movement property in the plurality of properties comprised in the property list, and obtaining the absolute pose information of the virtual object at the current moment from property information corresponding to the movement property in the property list.

6. The method according to claim 1, wherein the pose information belongs to information of a shared serialization type; after the obtaining relative pose information of the virtual object at the current moment, the method further comprises:
performing serialization processing on the obtained relative pose information by using the serialization mechanism, to obtain relative pose serialization data, and buffering the relative pose serialization data in local space; and
the writing the obtained relative pose information into a property synchronization data stream corresponding to the client by using the serialization mechanism comprises:
reading the relative pose serialization data from the local space in response to an information synchronization requirement of the client, and writing the relative pose serialization data into the property synchronization data stream corresponding to the client.

7. The method according to claim 1, further comprising:
obtaining a historical information identifier from a communication channel corresponding to the client, the historical information identifier being an information identifier of reference absolute pose information in the client; and the reference absolute pose information being absolute pose information of the virtual object received by the client last time before the current moment; and
when the historical information identifier satisfies a preset identification condition, determining that the reference absolute pose information in the client is valid absolute pose information, and triggering to perform the operation of writing the obtained relative pose information into a property synchronization data stream corresponding to the client by using the serialization mechanism; or
when the historical information identifier does not satisfy the preset identification condition, determining that the reference absolute pose information in the client is invalid absolute pose information, and writing the absolute pose information of the virtual object at the current moment into the property synchronization data stream corresponding to the client by using the serialization mechanism.

8. The method according to claim 1, wherein the obtained relative pose information is configured for indicating a difference between the absolute pose information of the virtual object at the current moment and absolute pose information of the virtual object at a previous moment, and the absolute pose information at the previous moment is pose information determined based on the reference object at the previous moment.

9. A computer device comprising:
a processor and a computer storage medium, the computer storage medium having one or more computer programs stored therein, the one or more computer programs being adapted to be loaded by the processor to perform an information synchronization method including:
obtaining absolute pose information of a virtual object in a virtual scene at a current moment, the absolute pose information at the current moment being pose information determined based on a reference object at the current moment;
determining a serialization mechanism for the absolute pose information;
when the serialization mechanism has the following value change characteristic: a data volume of data obtained by performing serialization on pose information by using the serialization mechanism is positively correlated with a value of the corresponding pose information, obtaining relative pose information of the virtual object at the current moment based on the value change characteristic of the serialization mechanism; and
writing the obtained relative pose information into a property synchronization data stream corresponding to a client by using the serialization mechanism, to transmit the property synchronization data stream to the client.

10. The computer device according to claim 9, wherein the method further comprises:
obtaining status information of the virtual object at the current moment, and determining a status condition that the virtual object is required to have when the relative pose information of the virtual object at the current moment is used;
when the virtual object has the status condition, performing the operation of obtaining relative pose information of the virtual object at the current moment based on the value change characteristic of the serialization mechanism; and
when the virtual object does not have the status condition, writing the absolute pose information of the virtual object at the current moment into the property synchronization data stream corresponding to the client by using the serialization mechanism.

11. The computer device according to claim 10, wherein the relative pose information of the virtual object at the current moment comprises at least one of the following: a relative velocity and a relative location;
the status information comprises at least one of the following: a status identifier configured for indicating whether the virtual object is attached to another virtual object, and a status identifier configured for indicating whether the virtual object is in physics simulation; and
the status condition comprises at least one of the following: the virtual object is not attached to another virtual object, and the virtual object is not in the physics simulation.

12. The computer device according to claim 10, wherein before the obtaining status information of the virtual object at the current moment, the method further comprises:
obtaining a function status of a global optimization function, the function status comprising an enabled state or a disabled state; and
when the function status of the global optimization function is the enabled state, performing the operation of obtaining status information of the virtual object at the current moment; or
when the function status of the global optimization function is the disabled state, obtaining an object type of the virtual object, and when the object type of the virtual object is a specified object type, performing the operation of obtaining relative pose information of the virtual object at the current moment based on the value change characteristic of the serialization mechanism.

13. The computer device according to claim 9, wherein the obtaining absolute pose information of a virtual object in a virtual scene at a current moment comprises:
obtaining a property list of the virtual object in the virtual scene at the current moment, the property list comprising a plurality of properties of the virtual object and property information of the virtual object under each property; and
searching for a movement property in the plurality of properties comprised in the property list, and obtaining the absolute pose information of the virtual object at the current moment from property information corresponding to the movement property in the property list.

14. The computer device according to claim 9, wherein the pose information belongs to information of a shared serialization type; after the obtaining relative pose information of the virtual object at the current moment, the method further comprises:
performing serialization processing on the obtained relative pose information by using the serialization mechanism, to obtain relative pose serialization data, and buffering the relative pose serialization data in local space; and
the writing the obtained relative pose information into a property synchronization data stream corresponding to the client by using the serialization mechanism comprises:
reading the relative pose serialization data from the local space in response to an information synchronization requirement of the client, and writing the relative pose serialization data into the property synchronization data stream corresponding to the client.

15. The computer device according to claim 9, wherein the method further comprises:
obtaining a historical information identifier from a communication channel corresponding to the client, the historical information identifier being an information identifier of reference absolute pose information in the client; and the reference absolute pose information being absolute pose information of the virtual object received by the client last time before the current moment; and
when the historical information identifier satisfies a preset identification condition, determining that the reference absolute pose information in the client is valid absolute pose information, and triggering to perform the operation of writing the obtained relative pose information into a property synchronization data stream corresponding to the client by using the serialization mechanism; or
when the historical information identifier does not satisfy the preset identification condition, determining that the reference absolute pose information in the client is invalid absolute pose information, and writing the absolute pose information of the virtual object at the current moment into the property synchronization data stream corresponding to the client by using the serialization mechanism.

16. The computer device according to claim 9, wherein the obtained relative pose information is configured for indicating a difference between the absolute pose information of the virtual object at the current moment and absolute pose information of the virtual object at a previous moment, and the absolute pose information at the previous moment is pose information determined based on the reference object at the previous moment.

17. A non-transitory computer storage medium, having one or more computer programs stored therein, the one or more computer programs being adapted to be loaded by a processor of a computer device to cause the computer device to perform an information synchronization method including:
obtaining absolute pose information of a virtual object in a virtual scene at a current moment, the absolute pose information at the current moment being pose information determined based on a reference object at the current moment;
determining a serialization mechanism for the absolute pose information;
when the serialization mechanism has the following value change characteristic: a data volume of data obtained by performing serialization on pose information by using the serialization mechanism is positively correlated with a value of the corresponding pose information, obtaining relative pose information of the virtual object at the current moment based on the value change characteristic of the serialization mechanism; and
writing the obtained relative pose information into a property synchronization data stream corresponding to a client by using the serialization mechanism, to transmit the property synchronization data stream to the client.

18. The non-transitory computer storage medium according to claim 17, wherein the method further comprises:
obtaining status information of the virtual object at the current moment, and determining a status condition that the virtual object is required to have when the relative pose information of the virtual object at the current moment is used;
when the virtual object has the status condition, performing the operation of obtaining relative pose information of the virtual object at the current moment based on the value change characteristic of the serialization mechanism; and
when the virtual object does not have the status condition, writing the absolute pose information of the virtual object at the current moment into the property synchronization data stream corresponding to the client by using the serialization mechanism.

19. The non-transitory computer storage medium according to claim 18, wherein the relative pose information of the virtual object at the current moment comprises at least one of the following: a relative velocity and a relative location;
the status information comprises at least one of the following: a status identifier configured for indicating whether the virtual object is attached to another virtual object, and a status identifier configured for indicating whether the virtual object is in physics simulation; and
the status condition comprises at least one of the following: the virtual object is not attached to another virtual object, and the virtual object is not in the physics simulation.

20. The non-transitory computer storage medium according to claim 17, wherein the obtained relative pose information is configured for indicating a difference between the absolute pose information of the virtual object at the current moment and absolute pose information of the virtual object at a previous moment, and the absolute pose information at the previous moment is pose information determined based on the reference object at the previous moment.
